(19) United States
(12) Patent Application Publication
(10) Pub. No.: US 2018/0356880 A1
(43) Pub. Date: Dec. 13, 2018

(54) INFORMATION PROCESSING METHOD AND APPARATUS, AND PROGRAM FOR EXECUTING THE INFORMATION PROCESSING METHOD ON COMPUTER

(71) Applicant: COLOPL, Inc., Tokyo (JP)

(72) Inventor: Takao KASHIHARA, Ibaraki (JP)

(21) Appl. No.: 15/952,268

(22) Filed: Jul. 9, 2018

(30) Foreign Application Priority Data
Apr. 14, 2017 (JP) 2017-080894
Apr. 14, 2017 (JP) 2017-080910

(51) Int. Cl. G06F 3/01; G06T 15/20; A63F 13/213; A63F 13/211; A63F 13/833

(52) U.S. Cl. CPC G06F 3/012; G06T 15/20; A63F 13/213; A63F 13/211; A63F 2300/8082; G06T 2210/21; A63F 2300/105; A63F 2300/1087; A63F 13/833

(57) ABSTRACT

A method includes defining a virtual space, wherein the virtual space comprises an operation object and a target object. The method further includes detecting a motion of a hand of a user. The method further includes moving the operation object in accordance with the detected motion of the hand of the user. The method further includes detecting a movement speed of the operation object or the hand of the user. The method further includes determining whether the operation object and the target object have collided in the virtual space. The method further includes determining whether a predetermined parameter of at least one of the operation object or the target object is to be varied in accordance with the determination that the operation object and the target object have collided. The method further includes identifying a variation amount of the predetermined parameter based on the detected movement speed.

### RELATED APPLICATIONS

The present application claims priority to Japanese Application Nos. 2017-080910 and 2017-080894, both filed on Apr. 14, 2017, the disclosures of which are hereby incorporated by reference herein in their entirety.

### TECHNICAL FIELD

This disclosure relates to a method for processing information, and a system for executing the information processing method.

### BACKGROUND

In Patent Document 1, there is described a technology for providing, in a virtual space, a battle game in which a user fights an enemy by operating an object, for example, a sword together with physical motion of the user.

### PATENT DOCUMENTS

[Patent Document 1] JP 5996138 B2

### SUMMARY

According to at least one aspect of this disclosure, there is provided a method including defining a virtual space, the virtual space including an operation object and a target object. The method further includes detecting a motion of a head-mounted device (HMD). The method further includes identifying a visual field in the virtual space in accordance with the motion of the HMD. The method further includes generating a visual-field image in accordance with the visual field. The method further includes displaying the visual-field image on the HMD. The method further includes detecting a motion of a hand of a user associated with the HMD. The method further includes moving the operation object in accordance with the motion of the hand of the user. The method further includes detecting a movement speed of the operation object or the hand of the user. The method further includes determining that the operation object and the target object have collided. The method further includes determining that a predetermined parameter is to be varied in accordance with the determination that the operation object and the target object have collided. The method further includes identifying a variation amount of the predetermined parameter in accordance with the movement speed.

### BRIEF DESCRIPTION OF THE DRAWINGS

FIG. 1 A diagram of a system including a head-mounted device (HMD) according to at least one embodiment of this disclosure.

FIG. 2 A block diagram of a hardware configuration of a computer according to at least one embodiment of this disclosure.

FIG. 3 A diagram of a uvw visual-field coordinate system to be set for an HMD according to at least one embodiment of this disclosure.

FIG. 4 A diagram of a mode of expressing a virtual space according to at least one embodiment of this disclosure.

FIG. 5 A diagram of a plan view of a head of a user wearing the HMD according to at least one embodiment of this disclosure.

FIG. 6 A diagram of a YZ cross section obtained by viewing a field-of-view region from an X direction in the virtual space according to at least one embodiment of this disclosure.

FIG. 7 A diagram of an XZ cross section obtained by viewing the field-of-view region from a Y direction in the virtual space according to at least one embodiment of this disclosure.

FIG. 8A A diagram of a schematic configuration of a controller according to at least one embodiment of this disclosure.

FIG. 8B A diagram of a coordinate system to be set for a hand of a user holding the controller according to at least one embodiment of this disclosure.

FIG. 9 A block diagram of a hardware configuration of a server according to at least one embodiment of this disclosure.

FIG. 10 A block diagram of a computer according to at least one embodiment of this disclosure.

FIG. 11 A sequence chart of processing to be executed by a system including an HMD set according to at least one embodiment of this disclosure.

FIG. 12A A schematic diagram of HMD systems of several users sharing the virtual space interact using a network according to at least one embodiment of this disclosure.

FIG. 12B A diagram of a field of view image of a HMD according to at least one embodiment of this disclosure.

FIG. 13 A sequence diagram of processing to be executed by a system including an HMD interacting in a network according to at least one embodiment of this disclosure.

FIG. 14 A block diagram of a configuration of modules of a computer according to at least one embodiment of this disclosure.

FIG. 15A A diagram of a user wearing an HMD and a controller according to at least one embodiment of this disclosure.

FIG. 15B A diagram of a virtual space including a virtual camera, a hand object, and a target object according to at least one embodiment of this disclosure.

FIG. 16 A flowchart of processing to be executed by an HMD set according to at least one embodiment of this disclosure.

FIG. 17 A flowchart of an example of processing of controlling a collision between objects according to at least one embodiment of this disclosure.

FIG. 18A A diagram of collision control between a weapon object and an enemy object according to at least one embodiment of this disclosure.

FIG. 18B A diagram of collision control between the weapon object and the enemy object according to at least one embodiment of this disclosure.

FIG. 18C A diagram of collision control between the weapon object and the enemy object according to at least one embodiment of this disclosure.

FIG. 19 A flowchart of an example of processing of controlling a collision between objects according to at least one embodiment of this disclosure.

FIG. 20A A diagram of collision control between the weapon object and an attack object according to at least one embodiment of this disclosure.

FIG. 20B A diagram of collision control between the weapon object and the attack object according to at least one embodiment of this disclosure.

FIG. 20C A diagram of collision control between the weapon object and the attack object according to at least one embodiment of this disclosure.

FIG. 21 A flowchart of an example of processing for evaluating an action in the virtual space by the user according to at least one embodiment of this disclosure.

FIG. 22A A diagram of a determination example according to at least one embodiment of this disclosure.

FIG. 22B A diagram of a determination example according to at least one embodiment of this disclosure.

FIG. 23 A diagram of a determination example according to at least one embodiment of this disclosure.

FIG. 24A A diagram of a determination example according to at least one embodiment of this disclosure.

FIG. 24B A diagram of a determination example according to at least one embodiment of this disclosure.

### DESCRIPTION OF EMBODIMENTS

Now, with reference to the drawings, at least one embodiment of this disclosure is described. In the following description, like components are denoted by like reference symbols. The same applies to the names and functions of those components. Therefore, detailed description of those components is not repeated.

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

[Configuration of HMD System]

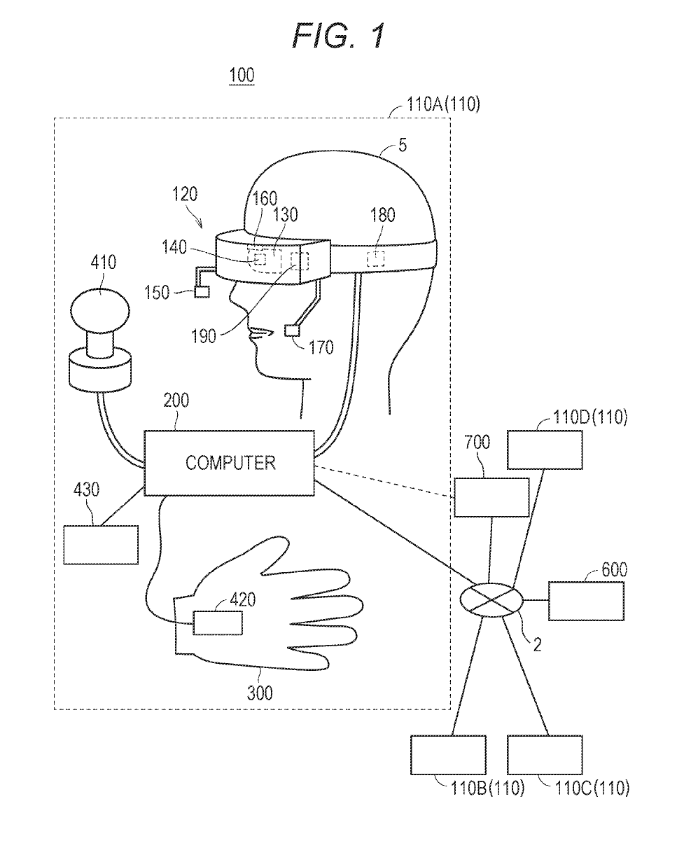

With reference to FIG. 1, a configuration of a head-mounted device (HMD) system 100 is described. FIG. 1 is a diagram of a system 100 including a head-mounted display (HMD) according to at least one embodiment of this disclosure. The system 100 is usable for household use or for professional use.

The system 100 includes a server 600, HMD sets 110A, 110B, 110C, and 110D, an external device 700, and a network 2. Each of the HMD sets 110A, 110B, 110C, and 110D is capable of independently communicating to/from the server 600 or the external device 700 via the network 2. In some instances, the HMD sets 110A, 110B, 110C, and 110D are also collectively referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. In at least one embodiment, the controller 300 includes a motion sensor 420.

In at least one aspect, the computer 200 is connected to the network 2, for example, the Internet, and is able to communicate to/from the server 600 or other computers connected to the network 2 in a wired or wireless manner. Examples of the other computers include a computer of another HMD set 110 or the external device 700. In at least one aspect, the HMD 120 includes a sensor 190 instead of the HMD sensor 410. In at least one aspect, the HMD 120 includes both sensor 190 and the HMD sensor 410.

The HMD 120 is wearable on a head of a user 5 to display a virtual space to the user 5 during operation. More specifically, in at least one embodiment, the HMD 120 displays each of a right-eye image and a left-eye image on the monitor 130. Each eye of the user 5 is able to visually recognize a corresponding image from the right-eye image and the left-eye image so that the user 5 may recognize a three-dimensional image based on the parallax of both of the user's the eyes. In at least one embodiment, the HMD 120 includes any one of a so-called head-mounted display including a monitor or a head-mounted device capable of mounting a smartphone or other terminals including a monitor.

The monitor 130 is implemented as, for example, a non-transmissive display device. In at least one aspect, the monitor 130 is arranged on a main body of the HMD 120 so as to be positioned in front of both the eyes of the user 5. Therefore, when the user 5 is able to visually recognize the three-dimensional image displayed by the monitor 130, the user 5 is immersed in the virtual space. In at least one aspect, the virtual space includes, for example, a background, objects that are operable by the user 5, or menu images that are selectable by the user 5. In at least one aspect, the monitor 130 is implemented as a liquid crystal monitor or an organic electroluminescence (EL) monitor included in a so-called smartphone or other information display terminals.

In at least one aspect, the monitor 130 is implemented as a transmissive display device. In this case, the user 5 is able to see through the HMD 120 covering the eyes of the user 5, for example, smartglasses. In at least one embodiment, the transmissive monitor 130 is configured as a temporarily non-transmissive display device through adjustment of a transmittance thereof. In at least one embodiment, the monitor 130 is configured to display a real space and a part of an image constructing the virtual space simultaneously. For example, in at least one embodiment, the monitor 130 displays an image of the real space captured by a camera mounted on the HMD 120, or may enable recognition of the real space by setting the transmittance of a part the monitor 130 sufficiently high to permit the user 5 to see through the HMD 120.

In at least one aspect, the monitor 130 includes a sub-monitor for displaying a right-eye image and a sub-monitor for displaying a left-eye image. In at least one aspect, the monitor 130 is configured to integrally display the right-eye image and the left-eye image. In this case, the monitor 130 includes a high-speed shutter. The high-speed shutter operates so as to alternately display the right-eye image to the right of the user 5 and the left-eye image to the left eye of the user 5, so that only one of the user's 5 eyes is able to recognize the image at any single point in time.

In at least one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In at least one aspect, the HMD sensor 410 is implemented by a camera. In at least one aspect, the HMD sensor 410 uses image information of the HMD 120 output from the camera to execute image analysis processing, to thereby enable detection of the position and the inclination of the HMD 120.

In at least one aspect, the HMD 120 includes the sensor 190 instead of, or in addition to, the HMD sensor 410 as a position detector. In at least one aspect, the HMD 120 uses the sensor 190 to detect the position and the inclination of the HMD 120. For example, in at least one embodiment, when the sensor 190 is an angular velocity sensor, a geomagnetic sensor, or an acceleration sensor, the HMD 120 uses any or all of those sensors instead of (or in addition to) the HMD sensor 410 to detect the position and the inclination of the HMD 120. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In at least one aspect, the eye gaze sensor 140 includes a right-eye sensor and a left-eye sensor. In at least one embodiment, the eye gaze sensor 140 is, for example, a sensor configured to irradiate the right eye and the left eye of the user 5 with an infrared ray, and to receive reflection light from the cornea and the iris with respect to the irradiation light, to thereby detect a rotational angle of each of the user's 5 eyeballs. In at least one embodiment, the eye gaze sensor 140 detects the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In at least one aspect, the first camera 150 is arranged on an exterior side of the HMD 120, and the second camera 160 is arranged on an interior side of the HMD 120. Images generated by the first camera 150 and the second camera 160 are input to the computer 200. In at least one aspect, the first camera 150 and the second camera 160 are implemented as a single camera, and the face of the user 5 is photographed with this single camera.

The microphone 170 converts an utterance of the user 5 into a voice signal (electric signal) for output to the computer 200. The speaker 180 converts the voice signal into a voice for output to the user 5. In at least one embodiment, the speaker 180 converts other signals into audio information provided to the user 5. In at least one aspect, the HMD 120 includes earphones in place of the speaker 180.

The controller 300 is connected to the computer 200 through wired or wireless communication. The controller 300 receives input of a command from the user 5 to the computer 200. In at least one aspect, the controller 300 is held by the user 5. In at least one aspect, the controller 300 is mountable to the body or a part of the clothes of the user 5. In at least one aspect, the controller 300 is configured to output at least any one of a vibration, a sound, or light based on the signal transmitted from the computer 200. In at least one aspect, the controller 300 receives from the user 5 an operation for controlling the position and the motion of an object arranged in the virtual space.

In at least one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In at least one aspect, the HMD sensor 410 is implemented by a camera. In this case, the HMD sensor 410 uses image information of the controller 300 output from the camera to execute image analysis processing, to thereby enable detection of the position and the inclination of the controller 300.

In at least one aspect, the motion sensor 420 is mountable on the hand of the user 5 to detect the motion of the hand of the user 5. For example, the motion sensor 420 detects a rotational speed, a rotation angle, and the number of rotations of the hand. The detected signal is transmitted to the computer 200. The motion sensor 420 is provided to, for example, the controller 300. In at least one aspect, the motion sensor 420 is provided to, for example, the controller 300 capable of being held by the user 5. In at least one aspect, to help prevent accidently release of the controller 300 in the real space, the controller 300 is mountable on an object like a glove-type object that does not easily fly away by being worn on a hand of the user 5. In at least one aspect, a sensor that is not mountable on the user 5 detects the motion of the hand of the user 5. For example, a signal of a camera that photographs the user 5 may be input to the computer 200 as a signal representing the motion of the user 5. As at least one example, the motion sensor 420 and the computer 200 are connected to each other through wired or wireless communication. In the case of wireless communication, the communication mode is not particularly limited, and for example, Bluetooth (trademark) or other known communication methods are usable.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

In at least one embodiment, the server 600 transmits a program to the computer 200. In at least one aspect, the server 600 communicates to/from another computer 200 for providing virtual reality to the HMD 120 used by another user. For example, when a plurality of users play a participatory game, for example, in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 is any suitable device as long as the external device 700 is capable of communicating to/from the computer 200. The external device 700 is, for example, a device capable of communicating to/from the computer 200 via the network 2, or is a device capable of directly communicating to/from the computer 200 by near field communication or wired communication. Peripheral devices such as a smart device, a personal computer (PC), or the computer 200 are usable as the external device 700, in at least one embodiment, but the external device 700 is not limited thereto.

[Hardware Configuration of Computer]

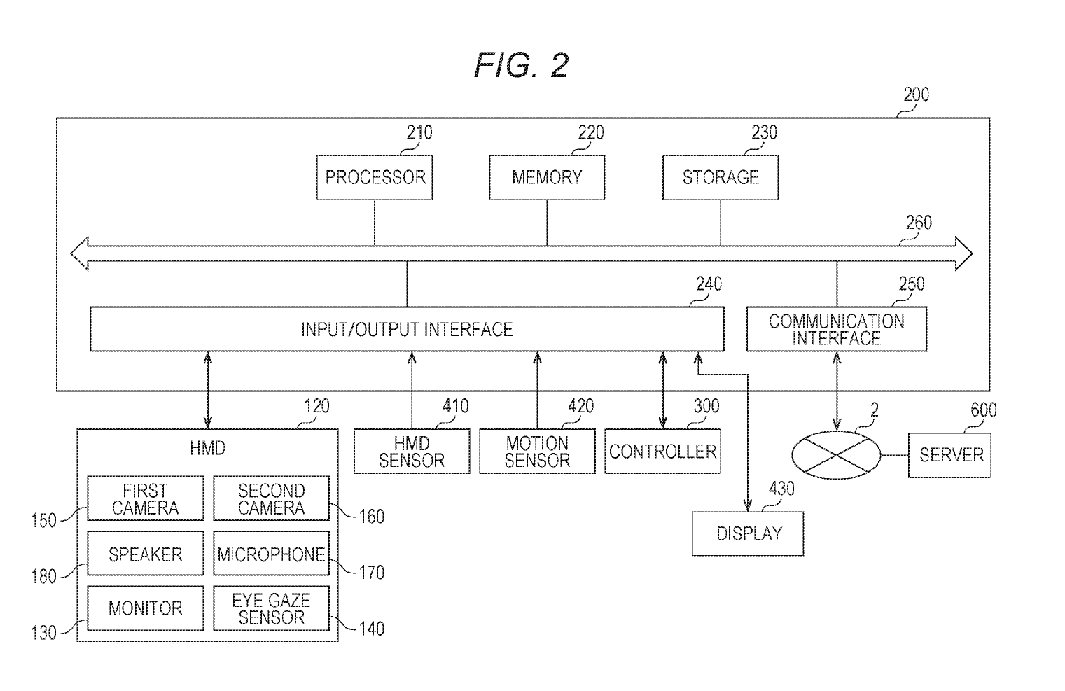

With reference to FIG. 2, the computer 200 in at least one embodiment is described. FIG. 2 is a block diagram of a hardware configuration of the computer 200 according to at least one embodiment. The computer 200 includes, a processor 210, a memory 220, a storage 230, an input/output interface 240, and a communication interface 250. Each component is connected to a bus 260. In at least one embodiment, at least one of the processor 210, the memory 220, the storage 230, the input/output interface 240 or the communication interface 250 is part of a separate structure and communicates with other components of computer 200 through a communication path other than the bus 260.

The processor 210 executes a series of commands included in a program stored in the memory 220 or the storage 230 based on a signal transmitted to the computer 200 or in response to a condition determined in advance. In at least one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In at least one aspect, the memory 220 is implemented as a random access memory (RAM) or other volatile memories.

The storage 230 permanently stores programs and data. In at least one embodiment, the storage 230 stores programs and data for a period of time longer than the memory 220, but not permanently. The storage 230 is implemented as, for example, a read-only memory (ROM), a hard disk device, a flash memory, or other non-volatile storage devices. The programs stored in the storage 230 include programs for providing a virtual space in the system 100, simulation programs, game programs, user authentication programs, and programs for implementing communication to/from other computers 200. The data stored in the storage 230 includes data and objects for defining the virtual space.

In at least one aspect, the storage 230 is implemented as a removable storage device like a memory card. In at least one aspect, a configuration that uses programs and data stored in an external storage device is used instead of the storage 230 built into the computer 200. With such a configuration, for example, in a situation in which a plurality of HMD systems 100 are used, for example in an amusement facility, the programs and the data are collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In at least one aspect, the input/output interface 240 is implemented with use of a universal serial bus (USB), a digital visual interface (DVI), a high-definition multimedia interface (HDMI) (trademark), or other terminals. The input/output interface 240 is not limited to the specific examples described above.

In at least one aspect, the input/output interface 240 further communicates to/from the controller 300. For example, the input/output interface 240 receives input of a signal output from the controller 300 and the motion sensor 420. In at least one aspect, the input/output interface 240 transmits a command output from the processor 210 to the controller 300. The command instructs the controller 300 to, for example, vibrate, output a sound, or emit light. When the controller 300 receives the command, the controller 300 executes any one of vibration, sound output, and light emission in accordance with the command.

The communication interface 250 is connected to the network 2 to communicate to/from other computers (e.g., server 600) connected to the network 2. In at least one aspect, the communication interface 250 is implemented as, for example, a local area network (LAN), other wired communication interfaces, wireless fidelity (Wi-Fi), Bluetooth (R), near field communication (NFC), or other wireless communication interfaces. The communication interface 250 is not limited to the specific examples described above.

In at least one aspect, the processor 210 accesses the storage 230 and loads one or more programs stored in the storage 230 to the memory 220 to execute a series of commands included in the program. In at least one embodiment, the one or more programs includes an operating system of the computer 200, an application program for providing a virtual space, and/or game software that is executable in the virtual space. The processor 210 transmits a signal for providing a virtual space to the HMD 120 via the input/output interface 240. The HMD 120 displays a video on the monitor 130 based on the signal.

In FIG. 2, the computer 200 is outside of the HMD 120, but in at least one aspect, the computer 200 is integral with the HMD 120. As an example, a portable information communication terminal (e.g., smartphone) including the monitor 130 functions as the computer 200 in at least one embodiment.

In at least one embodiment, the computer 200 is used in common with a plurality of HMDs 120. With such a configuration, for example, the computer 200 is able to provide the same virtual space to a plurality of users, and hence each user can enjoy the same application with other users in the same virtual space.

According to at least one embodiment of this disclosure, in the system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In at least one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which corresponds to the motion of the user 5 wearing the HMD 120, based on the value of each point (each coordinate value in the real coordinate system). In more detail, the HMD sensor 410 is able to detect the temporal change of the position and the inclination of the HMD 120 with use of each value detected over time.

Each inclination of the HMD 120 detected by the HMD sensor 410 corresponds to an inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

[Uvw Visual-Field Coordinate System]

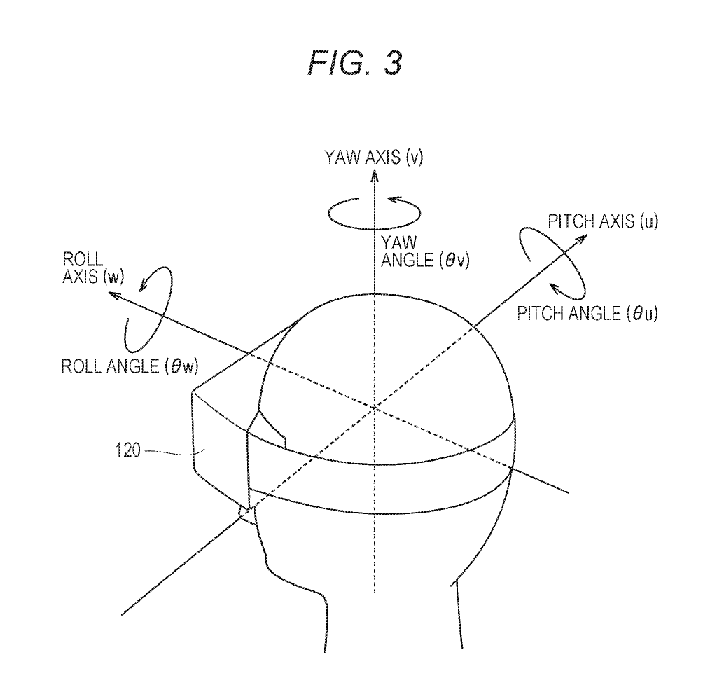

With reference to FIG. 3, the uvw visual-field coordinate system is described. FIG. 3 is a diagram of a uvw visual-field coordinate system to be set for the HMD 120 according to at least one embodiment of this disclosure. The HMD sensor 410 detects the position and the inclination of the HMD 120 in the real coordinate system when the HMD 120 is activated. The processor 210 sets the uvwvisual-field coordinate systemto the HMD 120 based on the detected values.

In FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In at least one aspect, when the user 5 wearing the HMD 120 is standing (or sitting) upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 is able to detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In at least one aspect, the HMD sensor 410 identifies the position of the HMD 120 in the real space as a position relative to the HMD sensor 410 based on the light intensity of the infrared ray or a relative positional relationship between a plurality of points (e.g., distance between points), which is acquired based on output from the infrared sensor. In at least one aspect, the processor 210 determines the origin of the uvw visual-field coordinate system of the HMD 120 in the real space (real coordinate system) based on the identified relative position.

[Virtual Space]

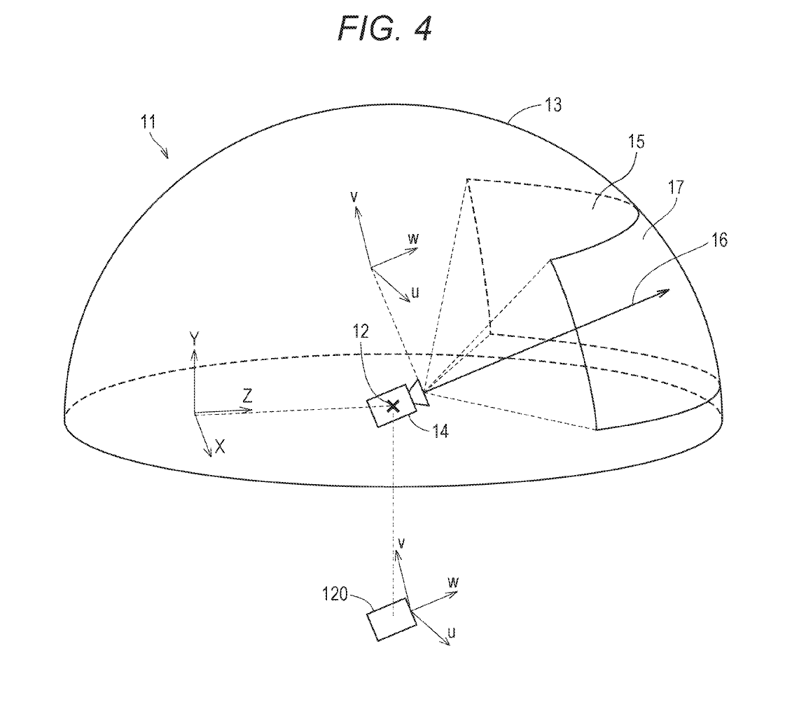

With reference to FIG. 4, the virtual space is further described. FIG. 4 is a diagram of a mode of expressing a virtual space 11 according to at least one embodiment of this disclosure. The virtual space 11 has a structure with an entire celestial sphere shape covering a center 12 in all 360-degree directions. In FIG. 4, for the sake of clarity, only the upper-half celestial sphere of the virtual space 11 is included. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that is developed in the virtual space 11 with each corresponding mesh section in the virtual space 11.

In at least one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In at least one embodiment, the virtual camera 14 is offset from the center 12 in the initial state. In at least one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space is reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 determines a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the system 100 in at least one aspect, the line of sight of the user 5 detected by the eye gaze sensor 140 can be regarded as the line of sight of the user 5 in the uvw visual-field coordinate system of the virtual camera 14.

[User's Line of Sight]

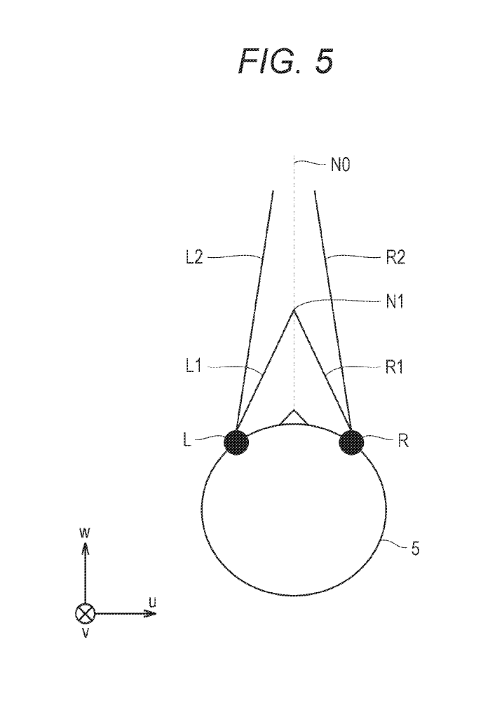

With reference to FIG. 5, determination of the line of sight of the user 5 is described. FIG. 5 is a plan view diagram of the head of the user 5 wearing the HMD 120 according to at least one embodiment of this disclosure.

In at least one aspect, the eye gaze sensor 140 detects lines of sight of the right eye and the left eye of the user 5. In at least one aspect, when the user 5 is looking at a near place, the eye gaze sensor 140 detects lines of sight R1 and L1. In at least one aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight NO of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight NO. The line of sight NO is a direction in which the user 5 actually directs his or her lines of sight with both eyes. The line of sight NO corresponds to a direction in which the user 5 actually directs his or her lines of sight with respect to the field-of-view region 15.

In at least one aspect, the system 100 includes a television broadcast reception tuner. With such a configuration, the system 100 is able to display a television program in the virtual space 11.

In at least one aspect, the HMD system 100 includes a communication circuit for connecting to the Internet or has a verbal communication function for connecting to a telephone line or a cellular service.

[Field-Of-View Region]

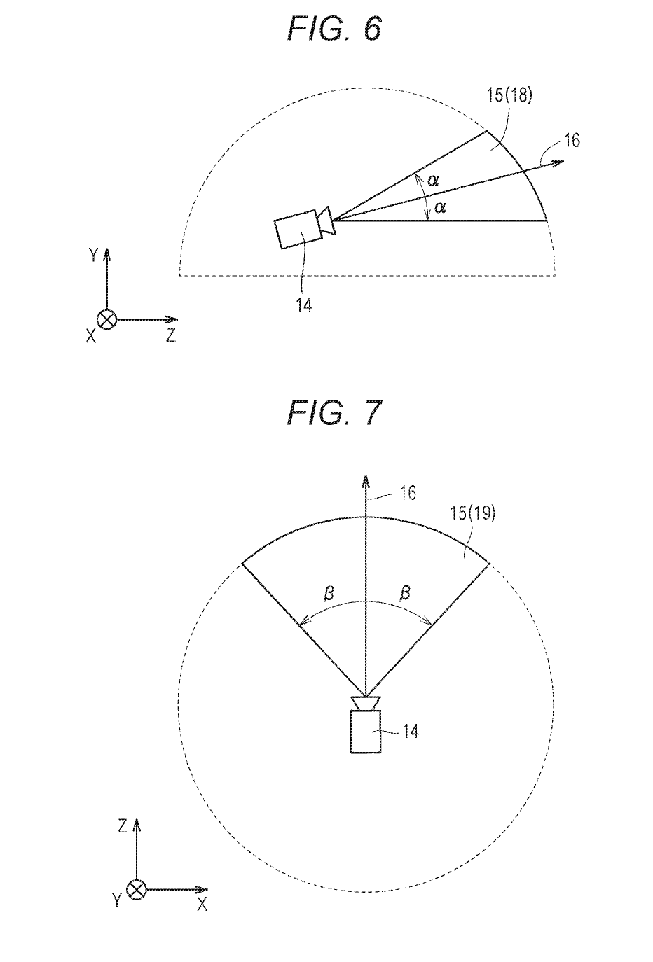

With reference to FIG. 6 and FIG. 7, the field-of-view region 15 is described. FIG. 6 is a diagram of a YZ cross section obtained by viewing the field-of-view region 15 from an X direction in the virtual space 11. FIG. 7 is a diagram of an XZ cross section obtained by viewing the field-of-view region 15 from a Y direction in the virtual space 11.

In FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle α from the reference line of sight 16 serving as the center in the virtual space as the region 18.

In FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth β from the reference line of sight 16 serving as the center in the virtual space 11 as the region 19. The polar angle α and β are determined in accordance with the position of the virtual camera 14 and the inclination (direction) of the virtual camera 14.

In at least one aspect, the system 100 causes the monitor 130 to display a field-of-view image 17 based on the signal from the computer 200, to thereby provide the field of view in the virtual space 11 to the user 5. The field-of-view image 17 corresponds to apart of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120 (having a non-transmissive monitor 130), the user 5 can visually recognize only the panorama image 13 developed in the virtual space 11 without visually recognizing the real world. Therefore, the system 100 provides a high sense of immersion in the virtual space 11 to the user 5.

In at least one aspect, the processor 210 moves the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In at least one aspect, the virtual camera 14 includes two virtual cameras, that is, a virtual camera for providing a right-eye image and a virtual camera for providing a left-eye image. An appropriate parallax is set for the two virtual cameras so that the user 5 is able to recognize the three-dimensional virtual space 11. In at least one aspect, the virtual camera 14 is implemented by a single virtual camera. In this case, a right-eye image and a left-eye image may be generated from an image acquired by the single virtual camera. In at least one embodiment, the virtual camera 14 is assumed to include two virtual cameras, and the roll axes of the two virtual cameras are synthesized so that the generated roll axis (w) is adapted to the roll axis (w) of the HMD 120.

[Controller]

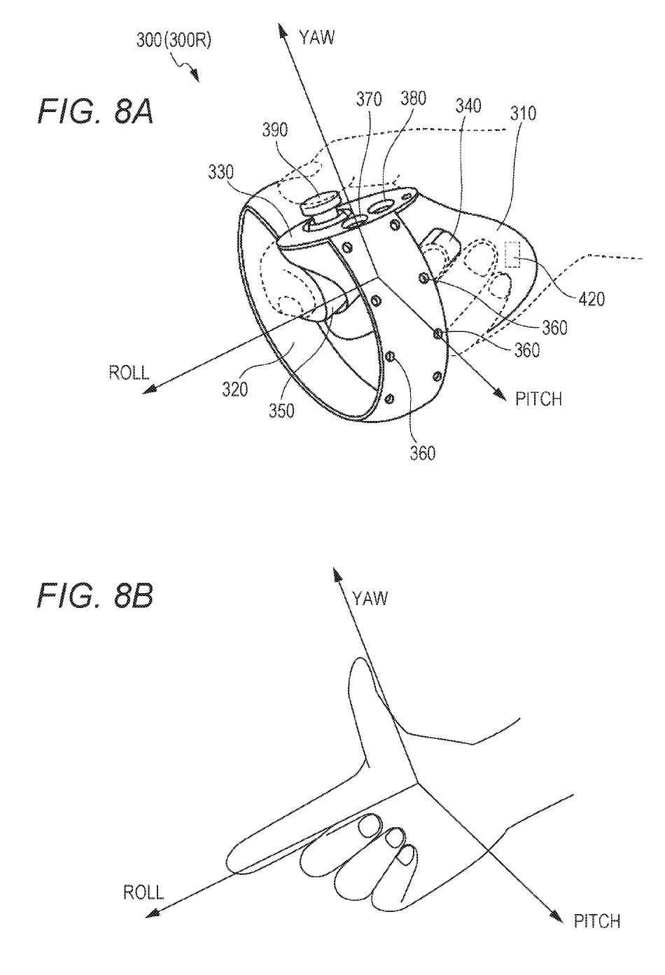

An example of the controller 300 is described with reference to FIG. 8A and FIG. 8B. FIG. 8A is a diagram of a schematic configuration of a controller according to at least one embodiment of this disclosure. FIG. 8B is a diagram of a coordinate system to be set for a hand of a user holding the controller according to at least one embodiment of this disclosure.

In at least one aspect, the controller 300 includes a right controller 300R and a left controller (not shown). In FIG. 8A only right controller 300R is shown for the sake of clarity. The right controller 300R is operable by the right hand of the user 5. The left controller is operable by the left hand of the user 5. In at least one aspect, the right controller 300R and the left controller are symmetrically configured as separate devices. Therefore, the user 5 can freely move his or her right hand holding the right controller 300R and his or her left hand holding the left controller. In at least one aspect, the controller 300 may be an integrated controller configured to receive an operation performed by both the right and left hands of the user 5. The right controller 300R is now described.

The right controller 300R includes a grip 310, a frame 320, and a top surface 330. The grip 310 is configured so as to be held by the right hand of the user 5. For example, the grip 310 may be held by the palm and three fingers (e.g., middle finger, ring finger, and small finger) of the right hand of the user 5.

The grip 310 includes buttons 340 and 350 and the motion sensor 420. The button 340 is arranged on a side surface of the grip 310, and receives an operation performed by, for example, the middle finger of the right hand. The button 350 is arranged on a front surface of the grip 310, and receives an operation performed by, for example, the index finger of the right hand. In at least one aspect, the buttons 340 and 350 are configured as trigger type buttons. The motion sensor 420 is built into the casing of the grip 310. When a motion of the user 5 can be detected from the surroundings of the user 5 by a camera or other device. In at least one embodiment, the grip 310 does not include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 are usable to independently detect the position and the posture (inclination and direction) of each of the right controller 300R and the left controller. In FIG. 8A, the infrared LEDs 360 are shown as being arranged in two rows, but the number of arrangement rows is not limited to that illustrated in FIG. 8. In at least one embodiment, the infrared LEDs 360 are arranged in one row or in three or more rows. In at least one embodiment, the infrared LEDs 360 are arranged in a pattern other than rows.

The top surface 330 includes buttons 370 and 380 and an analog stick 390. The buttons 370 and 380 are configured as push type buttons. The buttons 370 and 380 receive an operation performed by the thumb of the right hand of the user 5. In at least one aspect, the analog stick 390 receives an operation performed in any direction of 360 degrees from an initial position (neutral position). The operation includes, for example, an operation for moving an object arranged in the virtual space 11.

In at least one aspect, each of the right controller 300R and the left controller includes a battery for driving the infrared ray LEDs 360 and other members. The battery includes, for example, a rechargeable battery, a button battery, a dry battery, but the battery is not limited thereto. In at least one aspect, the right controller 300R and the left controller are connectable to, for example, a USB interface of the computer 200. In at least one embodiment, the right controller 300R and the left controller do not include a battery.

In FIG. 8A and FIG. 8B, for example, a yaw direction, a roll direction, and a pitch direction are defined with respect to the right hand of the user 5. A direction of an extended thumb is defined as the yaw direction, a direction of an extended index finger is defined as the roll direction, and a direction perpendicular to a plane is defined as the pitch direction.

[Hardware Configuration of Server]

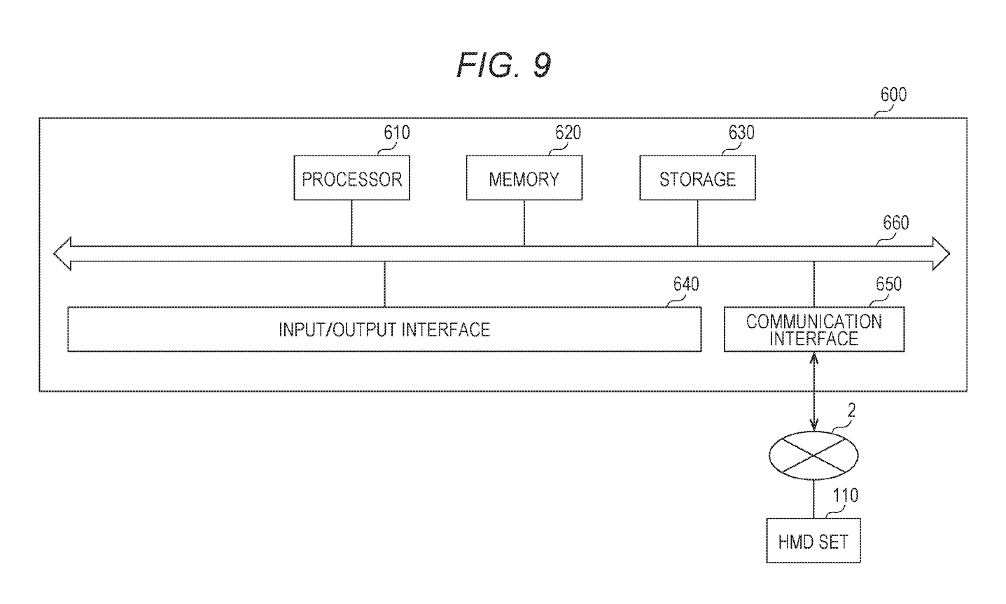

With reference to FIG. 9, the server 600 in at least one embodiment is described. FIG. 9 is a block diagram of a hardware configuration of the server 600 according to at least one embodiment of this disclosure. The server 600 includes a processor 610, a memory 620, a storage 630, an input/output interface 640, and a communication interface 650. Each component is connected to a bus 660. In at least one embodiment, at least one of the processor 610, the memory 620, the storage 630, the input/output interface 640 or the communication interface 650 is part of a separate structure and communicates with other components of server 600 through a communication path other than the bus 660.

The processor 610 executes a series of commands included in a program stored in the memory 620 or the storage 630 based on a signal transmitted to the server 600 or on satisfaction of a condition determined in advance. In at least one aspect, the processor 610 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In at least one aspect, the memory 620 is implemented as a random access memory (RAM) or other volatile memories.

The storage 630 permanently stores programs and data. In at least one embodiment, the storage 630 stores programs and data for a period of time longer than the memory 620, but not permanently. The storage 630 is implemented as, for example, a read-only memory (ROM), a hard disk device, a flash memory, or other non-volatile storage devices. The programs stored in the storage 630 include programs for providing a virtual space in the system 100, simulation programs, game programs, user authentication programs, and programs for implementing communication to/from other computers 200 or servers 600. The data stored in the storage 630 may include, for example, data and objects for defining the virtual space.

In at least one aspect, the storage 630 is implemented as a removable storage device like a memory card. In at least one aspect, a configuration that uses programs and data stored in an external storage device is used instead of the storage 630 built into the server 600. With such a configuration, for example, in a situation in which a plurality of HMD systems 100 are used, for example, as in an amusement facility, the programs and the data are collectively updated.

The input/output interface 640 allows communication of signals to/from an input/output device. In at least one aspect, the input/output interface 640 is implemented with use of a USB, a DVI, an HDMI, or other terminals. The input/output interface 640 is not limited to the specific examples described above.

The communication interface 650 is connected to the network 2 to communicate to/from the computer 200 connected to the network 2. In at least one aspect, the communication interface 650 is implemented as, for example, a LAN, other wired communication interfaces, Wi-Fi, Bluetooth, NFC, or other wireless communication interfaces. The communication interface 650 is not limited to the specific examples described above.

In at least one aspect, the processor 610 accesses the storage 630 and loads one or more programs stored in the storage 630 to the memory 620 to execute a series of commands included in the program. In at least one embodiment, the one or more programs include, for example, an operating system of the server 600, an application program for providing a virtual space, and game software that can be executed in the virtual space. In at least one embodiment, the processor 610 transmits a signal for providing a virtual space to the HMD device 110 to the computer 200 via the input/output interface 640.

[Control Device of HMD]

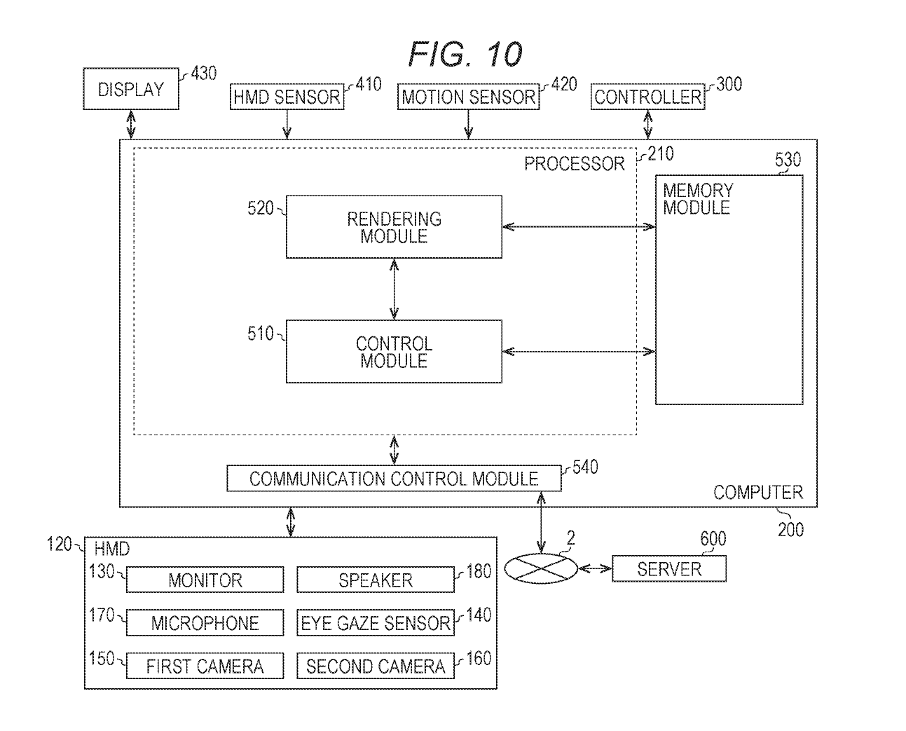

With reference to FIG. 10, the control device of the HMD 120 is described. According to at least one embodiment of this disclosure, the control device is implemented by the computer 200 having a known configuration. FIG. 10 is a block diagram of the computer 200 according to at least one embodiment of this disclosure. FIG. 10 includes a module configuration of the computer 200.

In FIG. 10, the computer 200 includes a control module 510, a rendering module 520, a memory module 530, and a communication control module 540. In at least one aspect, the control module 510 and the rendering module 520 are implemented by the processor 210. In at least one aspect, a plurality of processors 210 function as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. In at least one embodiment, the control module 510 generates virtual space data. In at least one embodiment, the control module 510 acquires virtual space data from, for example, the server 600.

The control module 510 arranges objects in the virtual space 11 using object data representing objects. The object data is stored in, for example, the memory module 530. In at least one embodiment, the control module 510 generates virtual space data. In at least one embodiment, the control module 510 acquires virtual space data from, for example, the server 600. In at least one embodiment, the objects include, for example, an avatar object of the user 5, character objects, operation objects, for example, a virtual hand to be operated by the controller 300, and forests, mountains, other landscapes, streetscapes, or animals to be arranged in accordance with the progression of the story of the game.

The control module 510 arranges an avatar object of the user 5 of another computer 200, which is connected via the network 2, in the virtual space 11. In at least one aspect, the control module 510 arranges an avatar object of the user 5 in the virtual space 11. In at least one aspect, the control module 510 arranges an avatar object simulating the user 5 in the virtual space 11 based on an image including the user 5. In at least one aspect, the control module 510 arranges an avatar object in the virtual space 11, which is selected by the user 5 from among a plurality of types of avatar objects (e.g., objects simulating animals or objects of deformed humans).

The control module 510 identifies an inclination of the HMD 120 based on output of the HMD sensor 410. In at least one aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In at least one aspect, the control module 510 is configured to transmit line-of-sight information representing the line of sight of the user 5 to the server 600. In such a case, the control module 510 may calculate the point-of-view position based on the line-of-sight information received by the server 600.

The control module 510 translates a motion of the HMD 120, which is detected by the HMD sensor 410, in an avatar object. For example, the control module 510 detects inclination of the HMD 120, and arranges the avatar object in an inclined manner. The control module 510 translates the detected motion of face parts in a face of the avatar object arranged in the virtual space 11. The control module 510 receives line-of-sight information of another user 5 from the server 600, and translates the line-of-sight information in the line of sight of the avatar object of another user 5. In at least one aspect, the control module 510 translates a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In at least one aspect, the operation object includes, for example, a hand object serving as a virtual hand corresponding to a hand of the user 5. In at least one aspect, the control module 510 moves the hand object in the virtual space 11 so that the hand object moves in association with a motion of the hand of the user 5 in the real space based on output of the motion sensor 420. In at least one aspect, the operation object may correspond to a hand part of an avatar object.

When one object arranged in the virtual space 11 collides with another object, the control module 510 detects the collision. The control module 510 is able to detect, for example, a timing at which a collision area of one object and a collision area of another object have touched with each other, and performs predetermined processing in response to the detected timing. In at least one embodiment, the control module 510 detects a timing at which an object and another object, which have been in contact with each other, have moved away from each other, and performs predetermined processing in response to the detected timing. In at least one embodiment, the control module 510 detects a state in which an object and another object are in contact with each other. For example, when an operation object touches another object, the control module 510 detects the fact that the operation object has touched the other object, and performs predetermined processing.

In at least one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 520 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs audio information (utterances) corresponding to the voice data from the speaker 180.

The memory module 530 holds data to be used to provide the virtual space 11 to the user 5 by the computer 200. In at least one aspect, the memory module 530 stores space information, object information, and user information.

The space information stores one or more templates defined to provide the virtual space 11.

The object information stores a plurality of panorama images 13 forming the virtual space 11 and object data for arranging objects in the virtual space 11. In at least one embodiment, the panorama image 13 contains a still image and/or a moving image. In at least one embodiment, the panorama image 13 contains an image in a non-real space and/or an image in the real space. An example of the image in a non-real space is an image generated by computer graphics.

The user information stores a user ID for identifying the user 5. The user ID is, for example, an internet protocol (IP) address or a media access control (MAC) address set to the computer 200 used by the user. In at least one aspect, the user ID is set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

In at least one embodiment, the communication control module 540 communicates to/from the server 600 or other information communication devices via the network 2.

In at least one aspect, the control module 510 and the rendering module 520 are implemented with use of, for example, Unity (R) provided by Unity Technologies. In at least one aspect, the control module 510 and the rendering module 520 are implemented by combining the circuit elements for implementing each step of processing.

The processing performed in the computer 200 is implemented by hardware and software executed by the processor 410. In at least one embodiment, the software is stored in advance on a hard disk or other memory module 530. In at least one embodiment, the software is stored on a CD-ROM or other computer-readable non-volatile data recording media, and distributed as a program product. In at least one embodiment, the software may is provided as a program product that is downloadable by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

[Control Structure of HMD System]

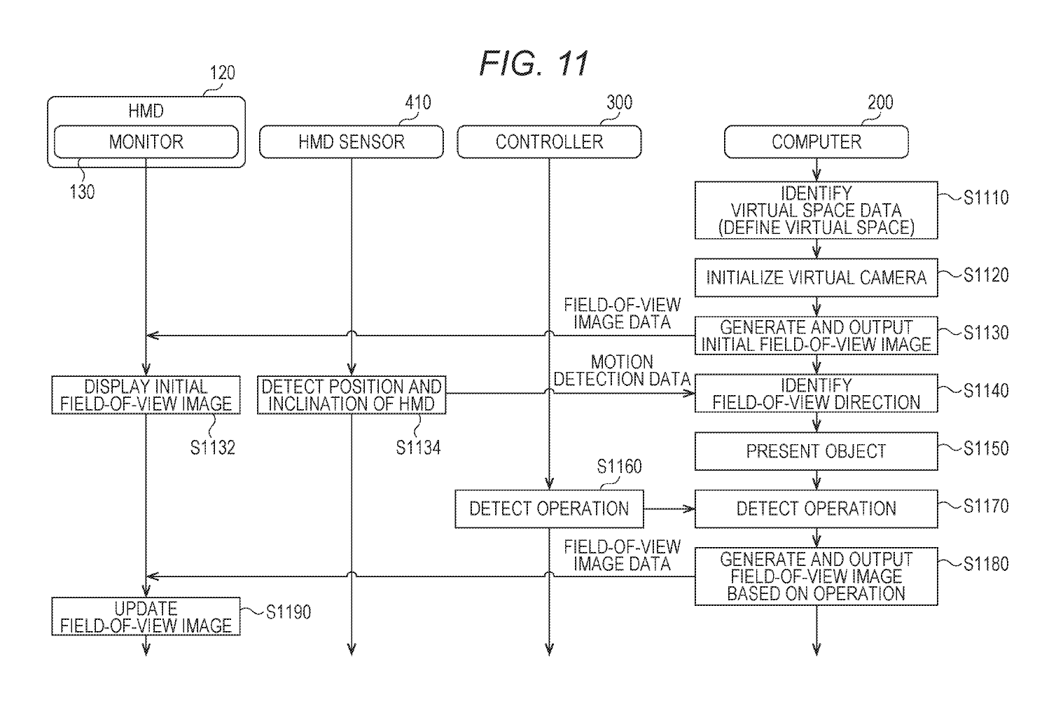

With reference to FIG. 11, the control structure of the HMD set 110 is described. FIG. 11 is a sequence chart of processing to be executed by the system 100 according to at least one embodiment of this disclosure.

In FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 is able to recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In at least one aspect, an operation of the controller 300 by the user 5 is detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field-of-view image data to the HMD 120.

In Step S1190, the HMD 120 updates a field-of-view image based on the received field-of-view image data, and displays the updated field-of-view image on the monitor 130.

[Avatar Object]

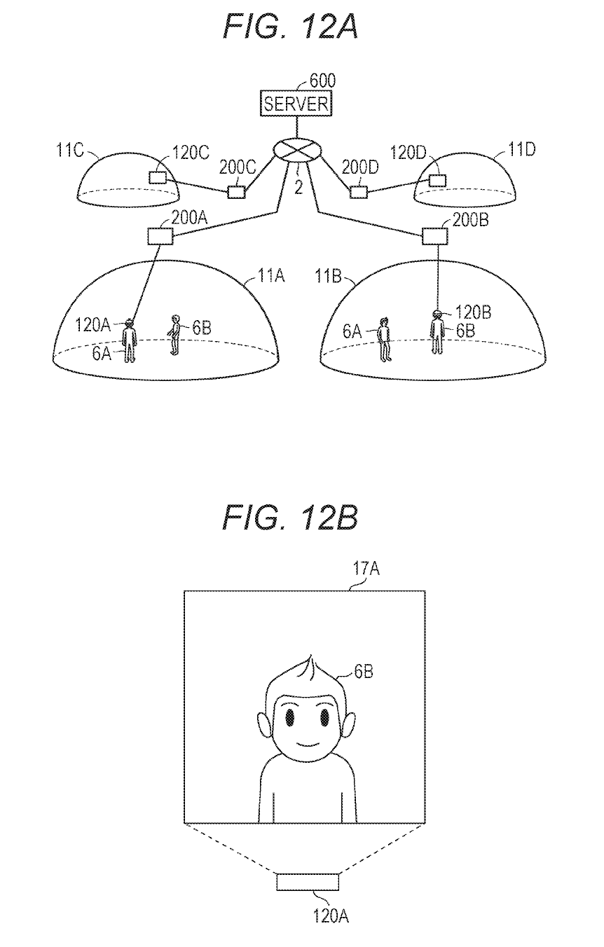

With reference to FIG. 12A and FIG. 12B, an avatar object according to at least one embodiment is described. FIG. 12 and FIG. 12B are diagrams of avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12A is a schematic diagram of HMD systems of several users sharing the virtual space interact using a network according to at least one embodiment of this disclosure. Each HMD 120 provides the user 5 with the virtual space 11. Computers 200A to 200D provide the users 5A to 5D with virtual spaces 11A to 11D via HMDs 120A to 120D, respectively. In FIG. 12A, the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, the inclusion of the HMD 120A and HMD 120B is only for the sake of simplicity of description, and the avatars do not wear the HMD 120A and HMD 120B in the virtual spaces 11A and 11B, respectively.

In at least one aspect, the processor 210A arranges a virtual camera 14A for photographing a field-of-view region 17A of the user 5A at the position of eyes of the avatar object 6A.

FIG. 12B is a diagram of a field of view of a HMD according to at least one embodiment of this disclosure. FIG. 12(B) corresponds to the field-of-view region 17A of the user 5A in FIG. 12A. The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not included in FIG. 12B, the avatar object 6A of the user 5A is displayed in the field-of-view image of the user 5B.

In the arrangement in FIG. 12B, the user 5A can communicate to/from the user 5B via the virtual space 11A through conversation. More specifically, voices of the user 5A acquired by a microphone 170A are transmitted to the HMD 120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A translates an operation by the user 5B (operation of HMD 120B and operation of controller 300B) in the avatar object 6B arranged in the virtual space 11A. With this, the user 5A is able to recognize the operation by the user 5B through the avatar object 6B.

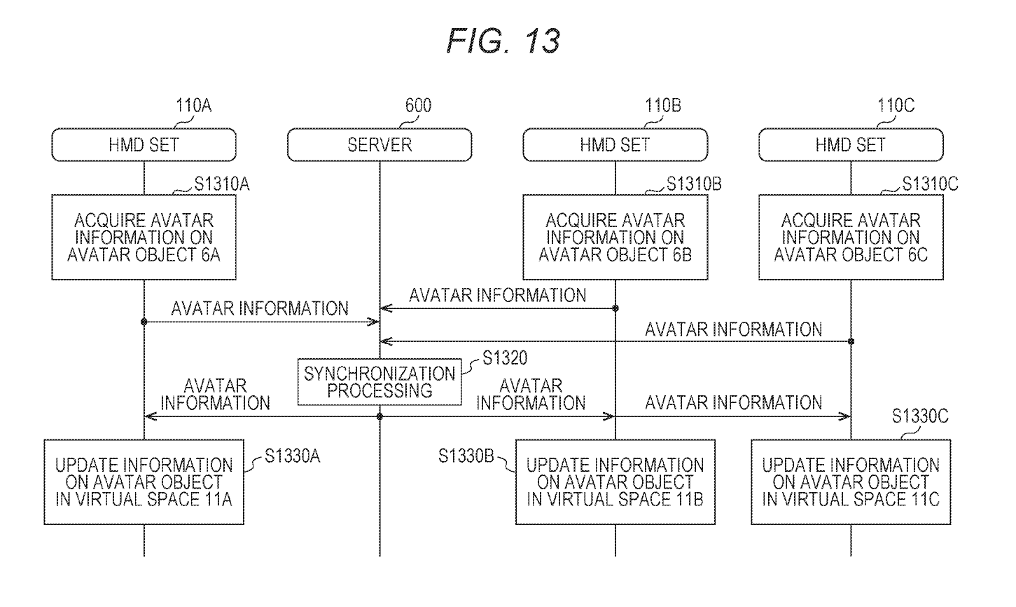

FIG. 13 is a sequence chart of processing to be executed by the system 100 according to at least one embodiment of this disclosure. In FIG. 13, although the HMD set 110D is not included, the HMD set 110D operates in a similar manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. In at least one embodiment, the avatar information contains information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210C of the HMD set 110C acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD 120C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 530. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

[Module Configuration]

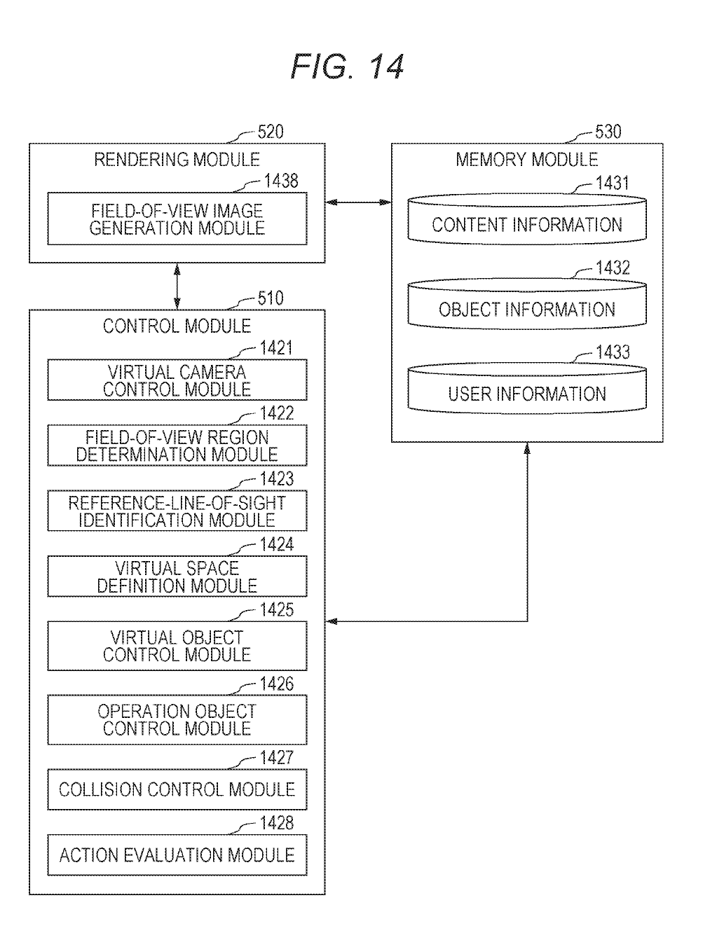

With reference to FIG. 14, a module configuration of the computer 200 are described. FIG. 14 is a block diagram of a configuration of modules of the computer according to at least one embodiment of this disclosure.

In FIG. 14, the control module 510 includes a virtual camera control module 1421, a field-of-view region determination module 1422, a reference-line-of-sight identification module 1423, a virtual space definition module 1424, a virtual object control module 1425, an operation object control module 1426, a collision control module 1427, and an action evaluation module 1428. The rendering module 520 includes a field-of-view image generation module 1438. The memory module 530 stores content information 1431, object information 1432, and user information 1433.

In at least one aspect, the control module 510 controls display of an image on the monitor 130 of the HMD 120. The virtual camera control module 1421 arranges the virtual camera 14 in the virtual space 11, and controls, for example, the behavior and direction of the virtual camera 14. The field-of-view region determination module 1422 defines the field-of-view region 15 in accordance with the direction of the head of the user wearing the HMD 120. The field-of-view image generation module 1438 generates a field-of-view image to be displayed on the monitor 130 based on the determined field-of-view region 15. The reference-line-of-sight identification module 1423 identifies the line of sight of the user 5 based on the signal from the eye gaze sensor 140.

The control module 510 controls the virtual space 11 to be provided to the user 5. The virtual space definition module 1424 generates virtual space data representing the virtual space 11, to thereby define the virtual space 11 in the HMD set 110.

The virtual object generation module 1425 generates virtual objects to be arranged in the virtual space 11 based on the content information 1431 and the object information 1432 to be described later. The virtual object control module 1425 also controls the motion (e.g., movements and state changes) of the virtual object in the virtual space 11.

The virtual object is any object to be arranged in the virtual space 11. The virtual object may be, for example, an animal or a landscape including forests, mountains, and the like, to be arranged in accordance with the progress of the game story. The virtual object may also be an avatar, which is an alter-ego of the user in the virtual space, or a character object such as a character (player character) in the game operated by the user. In the following description, in some instances, the virtual object is simply referred to as “object”.

The operation object control module 1426 controls the motion of the operation object, which is an object that moves in accordance with the motion of the hand of the user 5, in the virtual space 11. In at least one aspect, the operation object may be, for example, a hand object corresponding to the hand of the user 5 wearing the HMD 120, a finger object corresponding to the finger of the user 5, and the like. The objects operated by the hand object may also function as operation objects that move in accordance with the motion of the hand of the user 5. In at least one embodiment, a weapon object (e.g., object resembling a sword) that is held in the hand object and moves together with the hand object functions as an operation object.

The collision control module 1427 detects a collision when any one of the objects arranged in the virtual space 11 collides with another object. For example, the collision control module 1427 can detect the timing at which a given object contacts another object, and perform processing determined in advance when the detection is made. The collision control module 1427 can detect the timing at which objects that are in contact separate from each other, and perform processing determined in advance when the detection is made. The collision control module 1427 can detect that objects are in contact with each other. Specifically, when an operation object and another object are in contact with each other, the collision control module 1427 detects that that operation object and another object are in contact with each other, and performs processing determined in advance.

The collision control module 1427 determines a collision effect based on a speed of the motion of the hand of the user 5. The collision effect is, for example, the size of a collision area (described in detail later) defining a range in which the operation object collides with another object. The collision effect includes an effect (e.g., variation amount of predetermined parameter) generated by the collision control module 1427 when it is determined that the operation object and another object have collided based on the speed of the motion of the hand of the user 5.

The action evaluation module 1428 evaluates the action of the user 5 in the virtual space 11 based on the motion of the HMD 120 (i.e., motion of head of user 5) or the motion of the hand of the user 5. More specifically, the action evaluation module 1428 evaluates how well the avatar object 6 and the operation object look in the virtual space when the motion by the body of the user 5 in the real space is translated in the virtual space. The action evaluation module 1428 notifies the user 5 by displaying the evaluation result in the field-of-view image output to the monitor 130 or by outputting the evaluation result as a sound to a speaker or the like (not shown). The action evaluation module 1428 determines, based on the evaluation result, a game rank of the user 5 (level representing how well the action of user 5 looks).

The content information 1431 includes, for example, content to be reproduced in the virtual space 11 and information for arranging an object to be used in the content. The content may include, for example, a game or content representing a scenery similar to that of the real society. Specifically, the content information 1431 may include virtual space image data (virtual space image 22) defining a background of the virtual space 11 and definition information on the objects arranged in the virtual space 11. The definition information on the objects may include rendering information for rendering the objects (e.g., information representing design such as shape and color of object), information indicating an initial arrangement of the objects, and the like. The definition information on objects that move autonomously based on a motion pattern set in advance may include information (e.g., programs) indicating the motion pattern. An example of a motion based on a motion pattern determined in advance is a simple repetitive motion, like a motion in which an object resembling grass sways in a certain pattern.

The object information 1432 includes information indicating the state of each object arranged in the virtual space 11 (state capable of changing in accordance with, for example, game progress and operation by user 5). Specifically, the object information 1432 may include position information indicating the position of each object. The object information 1432 may further include motion information indicating the motion of an object capable of changing its shape (i.e., information for identifying an object shape). Examples of the object capable of changing its shape include objects that have, like the above-mentioned avatar, parts such as a head, a torso, hands, and the like, and that are capable of independently moving each part in accordance with the motion of the user 5.

The user information 1433 includes, for example, a program for causing the computer 200 to function as a control device for the HMD set 110, and an application program that uses each piece of content stored in the content information 1431.

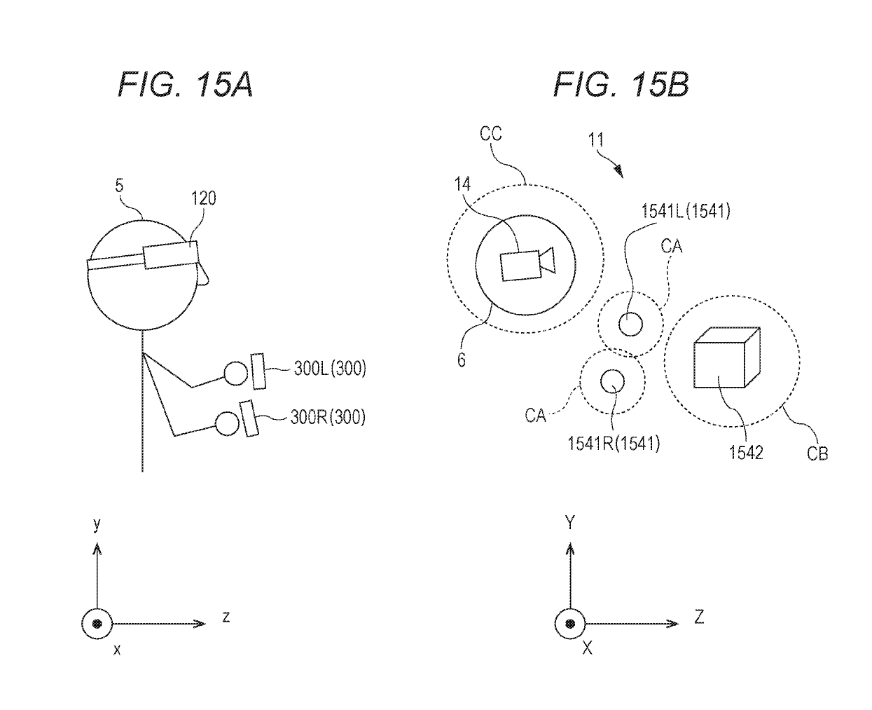

Details of the processing in which the collision control module 1427 determines a collision between the operation object and another object is now described with reference to FIG. 15A and FIG. 15B. FIG. 15A is a diagram of the user 5 wearing the HMD 120 and the controller 300 according to at least one aspect of this disclosure. FIG. 15B is a diagram of the virtual space 11 including the virtual camera 14, the hand object 1541, and the target object 1542 according to at least one aspect of this disclosure.

In FIG. 15B, the virtual space 11 includes the virtual camera 14, the avatar object 6, a left hand object 1541L, a right hand object 1541R, and the target object 1542. In at least one embodiment, the visual field of the avatar object 6 matches the visual field of the virtual camera 14. As a result, a field-of-view image in a first-person viewpoint is provided to the user. As described above, the virtual space definition module 1424 of the control module 510 generates virtual space data defining the virtual space 11 including such objects. As described above, the virtual camera 14 moves together with the motion of the HMD 120 worn by the user 5. In other words, the visual field of the virtual camera 14 is updated in accordance with the motion of the HMD 120. The right hand object 1541R is an operation object that moves in accordance with the motion of the right controller 300R worn on the right hand of the user 5. The left hand object 1541L is an operation object that moves in accordance with the motion of the left controller 300L worn on the left hand of the user 5. In the following, for convenience of description, the left hand object 1541L and the right hand object 1541R may each be generically referred to simply as the hand object 1541.

The left hand object 1541L and the right hand object 1541R each have a collision area CA. The target object 1542 has a collision area CB. The avatar object 6 has a collision area CC. The collision areas CA, CB, and CC are used for collision determination (hit determination) between the objects. For example, when the collision area CA of the hand object 1541 and the collision area CB of the target object 1542 are in contact (including case in which areas overlap each other), a determination is made that the hand object 1541 and the target object 1542 have collided. In FIG. 15B, the collision areas CA, CB, and CC may be defined by a sphere having a predetermined radius around a coordinate position set for each object.

[Control Structure]

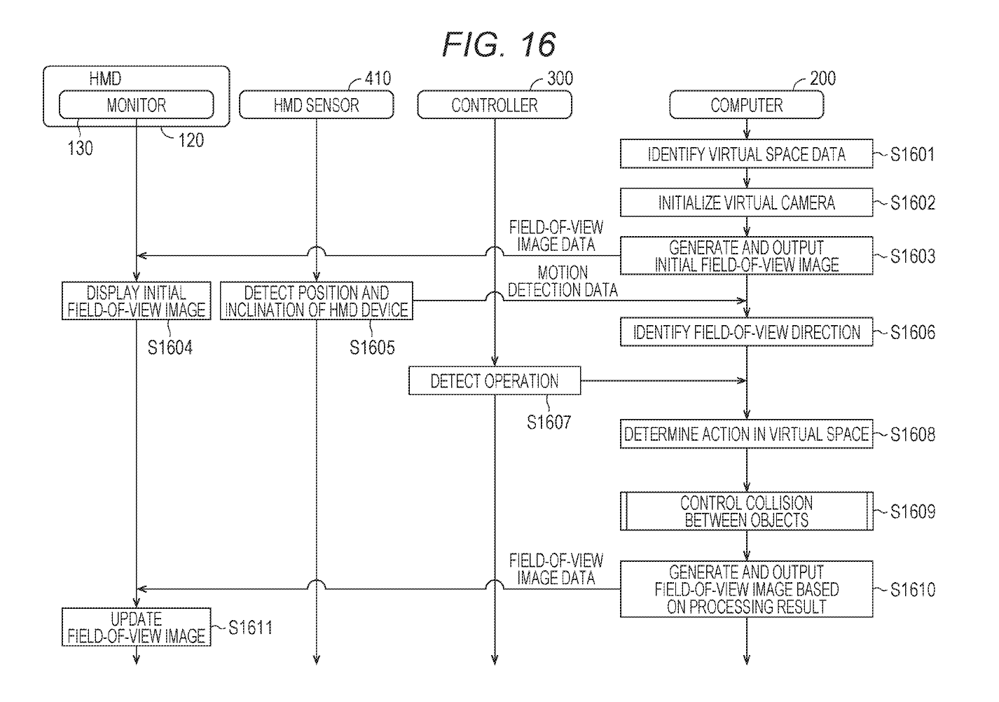

With reference to FIG. 16, the control structure of the computer 200 according to at least one embodiment of this disclosure is described. FIG. 16 is a flowchart of processing to be executed by the HMD set 110 according to at least one embodiment of this disclosure.

In Step S1601, the processor 210 of the computer 200 serves as the virtual space definition module 1424 to identify virtual space image data and define the virtual space. That is, the proces sor 210 generates virtual space data defining the virtual space 11.

In Step S1602, the processor 210 serves as the virtual camera control module 1421 to initialize the virtual camera 14. For example, in a work area of the memory, the processor 210 arranges the virtual camera 14 at the center defined in advance in the virtual space 11, and matches the line of sight of the virtual camera 14 with the direction in which the user 5 faces.

In Step S1603, the processor 210 serves as the field-of-view image generation module 1438 to generate field-of-view image data for displaying an initial field-of-view image. The generated field-of-view image data is transmitted to the HMD 120 by the communication control module 540 via the field-of-view image generation module 1438.

In Step S1604, the monitor 130 of the HMD 120 displays a field-of-view image based on a signal received from the computer 200. The user 5 wearing the HMD 120 may recognize the virtual space 11 through visual recognition of the field-of-view image.

In Step S1605, the HMD sensor 410 detects the position and inclination of the HMD 120 based on a plurality of infrared rays emitted from the HMD 120. The detection results are transmitted to the computer 200 as motion detection data.

In Step S1606, the processor 210 serves as the field-of-view region determination module 1422 to identify a field-of-view direction of the user 5 wearing the HMD 120 based on the position and inclination of the HMD 120. The processor 210 executes an application program, and arranges an object in the virtual space 11 based on a command contained in the application program.

In Step S1607, the controller 300 detects an operation performed by the user 5 in the real space. For example, in at least one aspect, the controller 300 detects that a button has been pressed by the user 5. In at least one aspect, the controller 300 detects a motion of a hand of the user 5 (e.g., motion of waving the hand). Specifically, the controller 300 detects the direction, speed, and the like of the hand of the user 5. A signal indicating the detection content is transmitted to the computer 200.

In Step S1608, the processor 210 serves as the virtual object control module 1425 to determine the action by the user 5 in the virtual space 11. For example, the processor 210 moves the avatar object 6 (in FIG. 15B, object corresponding to head of user 5 in at least one embodiment) based on the motion of the HMD 120 detected in Step S1605. The processor 210 moves the hand object 1541 based on the motion of the hand of the user 5 detected in Step S1607. When another object is held in the hand object 1541, the processor 210 moves that another object together with the hand object 1541.

In Step S1609, the processor 210 serves as the collision control module 1427 to execute control of a collision between objects. Embodiments of the processing of Step S1609 is described in more detail later.

In Step S1610, the processor 210 serves as the field-of-view region determination module 1422 and the field-of-view image generating module 1438 to generate field-of-view image data for displaying a field-of-view image based on the results of the processing, and output the generated field-of-view image data to the HMD 120.

In Step S1611, the monitor 130 of the HMD 120 updates a field-of-view image based on the received field-of-view image data, and displays the updated field-of-view image.

The processing of Step S1605 to Step S1611 is periodically repeated.

[Collision Control (Attack Motion)]

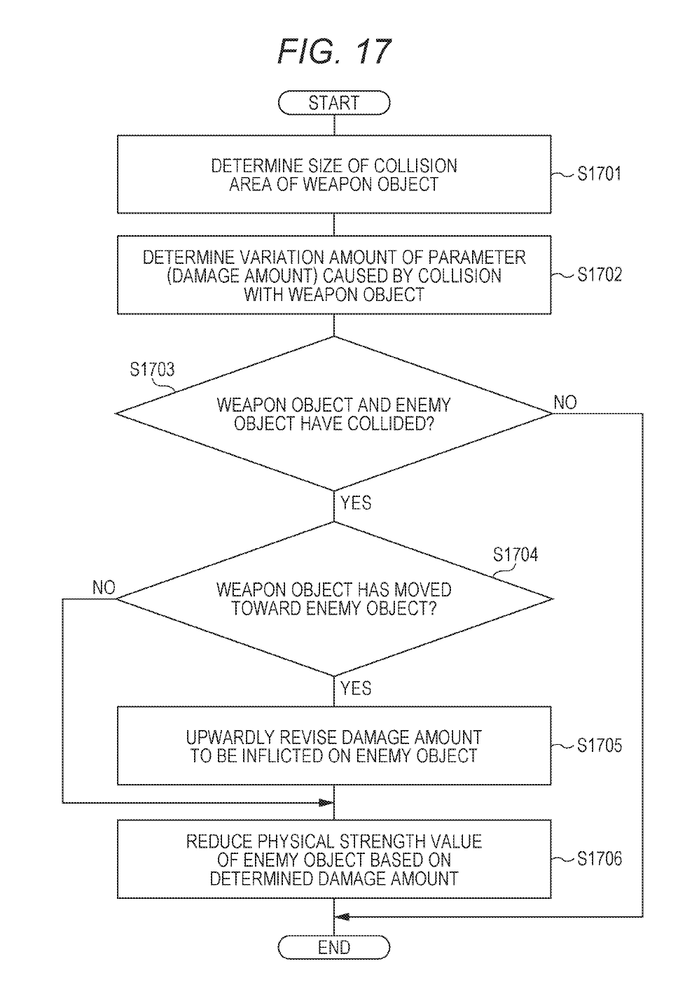

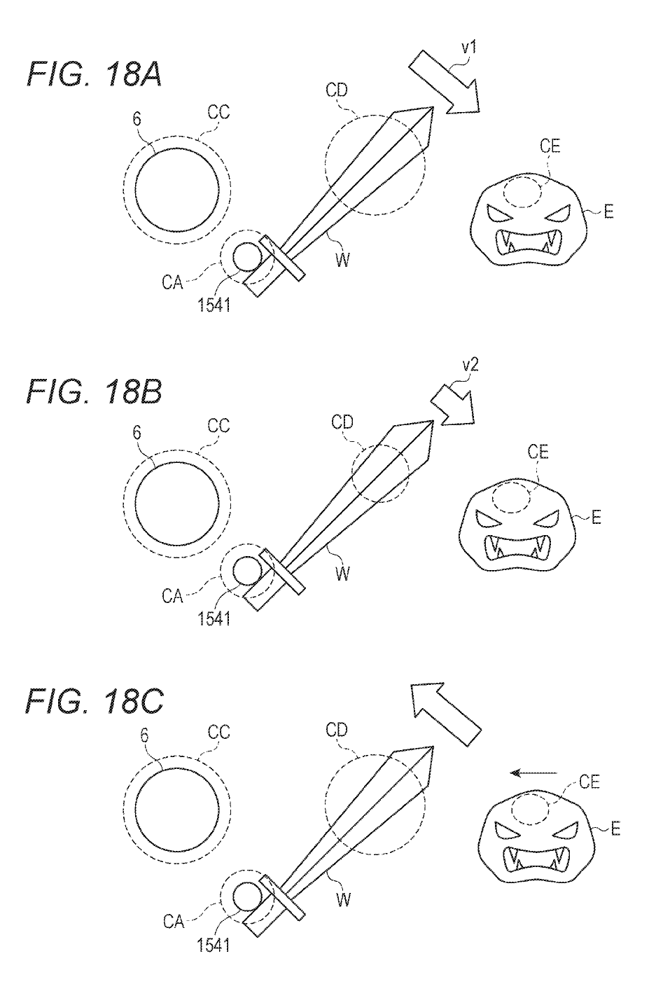

At least one embodiment of the processing procedure of collision control (Step S1609) focusing on an attack motion is now described with reference to FIG. 17 and FIG. 18A to FIG. 18C. Specifically, the processing procedure of the collision control between a weapon object W and an enemy object E is described. In FIG. 18A to FIG. 18C, the weapon object W is an operation object that is held in the hand object 1541 and that resembles a sword that moves together with the hand object 1541. In at least one embodiment, the weapon object W is an object other than a sword. The enemy object E is a target object to be attacked by the weapon object W. A collision area CD is set for the weapon object W, and a collision area CE is set for the enemy object E. There is set in advance between the weapon object W and the enemy object E a relationship in which damage is inflicted on the enemy object E when the weapon object W collides with the enemy object E (i.e., when collision between collision area CD and collision area CE is detected).

In Step S1701, the processor 210 determines the size of the collision area CD associated with the weapon object W based on the movement speed of the weapon object W (i.e., movement speed corresponding to detected speed of motion of hand of user 5).

The processor 210 may increase the size of the collision area CD when the movement speed of the weapon object W is faster. When the user 5 moves his or her hand rapidly, hitting the enemy object E with the weapon object W is more difficult. In that case, a more intuitive virtual experience may be provided to the user 5 by adjusting how easily his or her attack is able to hit the enemy object E in accordance with the movement speed of the weapon object W.

The processor 210 may continuously change the size of the collision area CD in accordance with the moving speed of the weapon object W. For example, the processor 210 may determine the size of the collision area CD by using a function F determined in advance in order to obtain a size F (x) of the collision area CD corresponding to a movement speed x of the weapon object W. The function F may be a monotonically increasing function satisfying, for arbitrary movement speeds x1 and x2, F(x1)>F(x2) when x1>x2. In this case, the processor 210 can increase the size of the collision area CD more when the movement speed of the weapon object W is faster based on a calculation using the function F.

The processor 210 may also discretely change the size of the collision area CD in accordance with the movement speed of the weapon object W. For example, the processor 210 may compare the movement speed of the weapon object W with a threshold determined in advance, and determine the size of the collision area CD such that the size when the movement speed is equal to or more than the threshold is larger than when the movement speed is less than the threshold. When a plurality of such thresholds are set, the size of the collision area CD may be changed stepwise in accordance with the movement speed of the weapon object W.

FIG. 18A is a diagram of the collision area CD when the movement speed of the weapon object W is v1, and FIG. 18B is a diagram of the collision area CD when the movement speed of the weapon object W is v2 (<v1). In at least one embodiment, as in FIG. 18A and FIG. 18B, the size of the collision area CD is larger when the movement speed of the weapon object W is faster. Therefore, the ease with which the weapon object W hits the enemy object E can be appropriately adjusted in accordance with the speed at which the user 5 moves his or her hand.

In Step S1702, the processor 210 determines, based on the movement speed of the weapon object W, a variation amount of a predetermined parameter that is generated in response to a determination based on the collision area CD that the weapon object W and the enemy object E have collided. The predetermined parameter is, for example, a physical strength value (so-called hit points) associated with the enemy object E. In this case, the variation amount of the predetermined parameter is the damage amount inflicted on the enemy object E (i.e., amount of reduction in physical strength value of enemy object E).

The processor 210 may increase the amount of damage inflicted on the enemy object E when the movement speed of the weapon object W is faster. In this case, when the user 5 moves his or her hand quickly and performs an attack motion, the effect of the attack on the enemy object E is greater. As a result, the user 5 is prompted to enjoy the game by dynamically moving his or her body.

In Step S1703, the processor 210 determines, based on the collision area CD and the collision area CE, whether the weapon object W and the enemy object E have collided. When a collision is not detected (Step S1703: NO), the processor 210 ends the processing. On the other hand, when a collision is detected (Step S1703: YES), the processor 210 advances the processing to Step S1704.

The processing of Step S1704 and Step S1705 is processing for determining (correcting), based on the movement direction of the weapon object W with respect to the enemy object E, the damage amount to be inflicted on the enemy object E.

In Step S1704, the processor 210 determines, based on the movement direction of the weapon object W (i.e., movement direction in virtual space 11 identified based on detected motion of hand of user 5), whether a collision has occurred as a result of the weapon object W moving toward the enemy object E.

In response to a determination that a collision has occurred as a result of the weapon object W moving toward the enemy object E (Step S1704: YES), the processor 210 upwardly revises the damage amount to be inflicted on the enemy object E in Step S1705. On the other hand, in response to a determination that a collision has occurred as a result of the weapon object W moving toward the enemy object E (Step S1704: NO), the processor 210 does not upwardly revise the damage amount to be inflicted on the enemy object E. FIG. 18C is a diagram of a state immediately before the enemy object E coming toward the weapon object W accidentally collides with the weapon object W when the user 5 swings up the weapon object W. In this way, when the weapon object W and the enemy object E collide with each other while the weapon object W is moving away from the enemy object E, the determination result in Step S1704 is “NO”.

Through such processing, the attack effect when the weapon object W collides with the enemy object E as a result of the user 5 intentionally performing an attack motion can be set higher than when the weapon object W accidentally collides with the enemy object E. As a result, the user 5 is prompted to actively perform attack motions, which enables further improvement in game enjoyment. In response to a determination that a collision has occurred as a result of the weapon object W moving toward the enemy object E (Step S1704: NO), the processor 210 may downwardly revise the damage amount to be inflicted on the enemy object E. In this case as well, the same effect as described above may be obtained.

In Step S1706, the processor 210 executes processing in accordance with the relationship between the weapon object W and the enemy object E. As described above, between the weapon object W and the enemy object E, there is determined in advance a relationship in which damage can be inflicted on the enemy object E when the weapon object W collides with the enemy object E. Therefore, the processor 210 reduces the physical strength value of the enemy object E based on the damage amount determined in Step S1702 and Step S1705.

In the above example, there is described a case in which the predetermined parameter is the physical strength value associated with the enemy object E, but the predetermined parameter is not limited to this. For example, the predetermined parameter may be an anger level of the enemy object E (e.g., parameter for changing attack pattern of the enemy object E when a fixed amount of anger or more has been accumulated) or the like. The predetermined parameter may also be a score obtained by attacking the enemy object E with the weapon object W, an amount of in-game currency, and the like.

[Collision Control (Defensive Motion)]

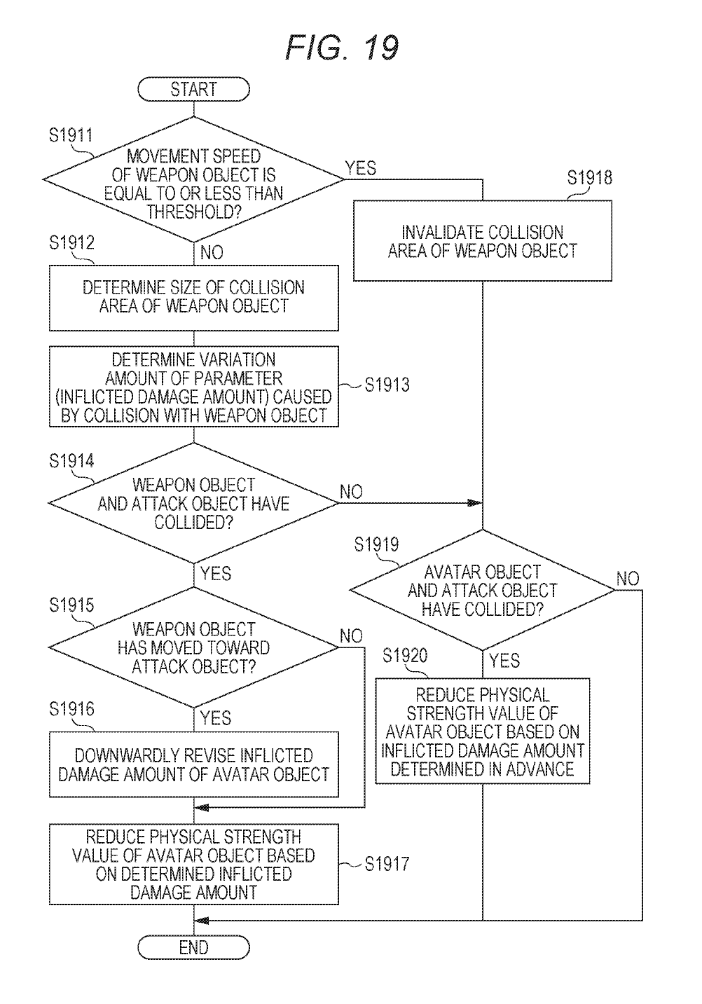

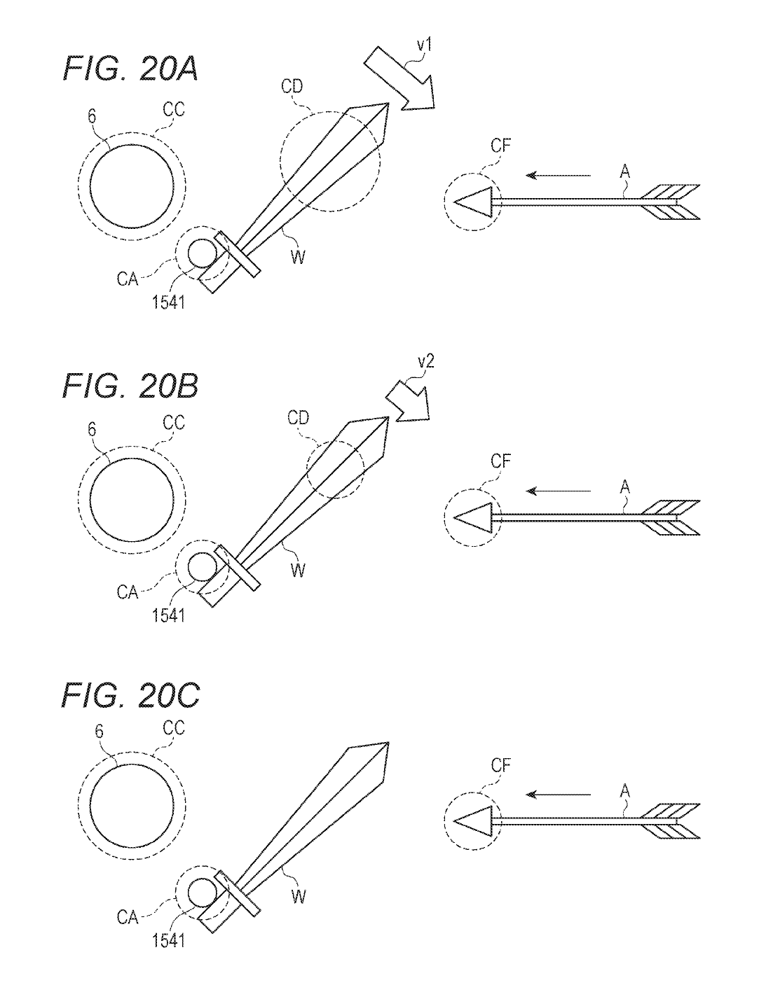

At least one embodiment of the processing procedure of collision control (Step S1609) focusing on a defensive motion is now described with reference to FIG. 19 and FIG. 20. Specifically, the processing procedure of the collision control between a weapon object W and an attack object A is described. In FIG. 20A to FIG. 20C, the attack object A is a target object that attacks the avatar object 6. In at least this example, the attack object A is an object resembling a projectile (in this example, an arrow) released from the enemy object E, for example. However, the attack object A is not limited to this example, and may be, for example, a part of the body of the enemy object E (e.g., arm swung by enemy object E), or a weapon or the like held by the enemy object E in its hand. A collision area CF is set for the attack object A. Between the avatar object 6 and the attack object A, there is determined in advance a relationship in which the avatar object 6 receives damage when the avatar object 6 collides with the attack object A (i.e., when a collision between the collision area CC and the collision area CF is detected). On the other hand, between the weapon object W and the attack object A, there is determined in advance a relationship in which the avatar object 6 may receive damage when the weapon object W collides with the attack object A. However, the inflicted damage amount on the avatar object 6 when the weapon object W collides with the attack object A is set to a value smaller than (or 0) the inflicted damage amount when the avatar object 6 collides with the attack object A. Specifically, the user 5 may lessen the inflicted damage amount on the avatar object 6 (or reduce to 0) by causing the weapon object W to collide with the attack object A to destroy or parry the attack object A.

In Step S1911, the processor 210 determines whether the movement speed of the weapon object W is equal to or less than a threshold determined in advance. In response to a determination that the movement speed is not equal to or less than the threshold (Step S1911: NO), the processor 210 advances the processing to Step S1912.

In Step S1912, the processor 210 determines, based on the movement speed of the weapon object W, the size of the collision area CD associated with the weapon object W in the same manner as the processing of Step S1701 described above. More specifically, the processor 210 increases the size of the collision area CD when the movement speed of the weapon object W is faster.

FIG. 20A is a diagram of the collision area CD when the movement speed of the weapon object W is v1, and FIG. 20B is a diagram of the collision area CD when the movement speed of the weapon object W is v2 (<v1). In at least one embodiment, as in FIG. 20A and FIG. 20B, the size of the collision area CD is larger when the movement speed of the weapon object W is faster. Therefore, the ease with which the weapon object W hits the attack object A can be appropriately adjusted in accordance with the speed at which the user 5 moves his or her hand.

In Step S1913, the processor 210 determines, based on the movement speed of the weapon object W, a variation amount of a predetermined parameter that is generated in response to a determination based on the collision area CD that the weapon object W and the attack object A have collided. The predetermined parameter is, for example, a physical strength value (so-called hit points) associated with the avatar object 6. In this case, the variation amount of the predetermined parameter is the damage amount inflicted on the avatar object 6 (i.e., amount of reduction in physical strength value of avatar object 6).

The processor 210 may decrease the amount of damage inflicted on the avatar object 6 when the movement speed of the weapon object W is faster. In this case, when the user 5 has moved his or her hand to perform a defensive motion (e.g., motion for parrying or destroying attack object A with weapon object W), the defensive effect against the attack object A is increased. As a result, the user 5 is prompted to enjoy the game by dynamically moving his or her body.

In Step S1914, the processor 210 determines, based on the collision area CD and the collision area CF, whether the weapon object W and the attack object A have collided. When a collision is detected (Step S1914: YES), the processor 210 advances the processing to Step S1915.

The processing of Step S1915 and Step S1916 is processing for determining (correcting), based on the movement direction of the weapon object W with respect to the attack object A, the damage amount to be inflicted on the avatar object 6.

In Step S1915, the processor 210 determines, based on the movement direction of the weapon object W, whether a collision has occurred as a result of the weapon object W moving toward the attack object A.

In response to a determination that a collision has occurred as a result of the weapon object W moving toward the attack object A (Step S1915: YES), the processor 210 downwardly revises the damage amount to be inflicted on the avatar object 6 in Step S1916. On the other hand, in response to a determination that a collision has not occurred as a result of the weapon object W moving toward the attack object A (Step S1915: NO), the processor 210 does not downwardly revise the damage amount to be inflicted on the avatar object 6.

Through such processing, the attack effect when the weapon object W collides with the attack object A as a result of the user 5 intentionally performing a defensive motion can be set higher than when the weapon object W accidentally collides with the attack object A. As a result, the user 5 is prompted to actively perform defensive motions, which enables further improvement in game enjoyment. In response to a determination that a collision has not occurred as a result of the weapon object W moving toward the attack object A (Step S1915: NO), the processor 210 may upwardly revise the damage amount to be inflicted from the attack object A. In this case as well, the same effect as described above may be obtained.

In Step S1917, the processor 210 executes processing in accordance with the relationship between the weapon object W and the attack object A. As described above, between the weapon object W and the attack object A, there is determined in advance a relationship in which the avatar object 6 receives damage when the weapon object W collides with the arrack object A. Therefore, when the inflicted damage amount determined in Step S1913 and Step S1916 is more than 0, the processor 210 reduces the physical strength value of the avatar object 6 based on the inflicted damage amount.

The processor 210 may determine, in accordance with the movement speed of the weapon object W, an effect value to be given to the attack object A when the weapon object W collides with the attack object A. The processor 210 may also change the effect given to the attack object A by the weapon object W in accordance with the determined effect value. For example, the processor 210 may destroy the attack object A into multiple pieces when the effect value is equal to or more than a threshold determined in advance, or parry the attack object A when the effect value is less than the threshold.

Next, the processing to be executed when the determination result of Step S1911 is “YES” is described. In this case, in Step S1918, the processor 210 invalidates the collision area CD of the weapon object W. The processor 210 may cause the collision area CD to disappear, or when the collision area CD and the collision area of another object overlap, may set for the collision area CD flag information or the like indicating that a collision is not detected. In FIG. 20C, there is at least one example in which the collision area CD of the weapon object W is caused to disappear. In this way, when the movement speed of the weapon object W is less than the threshold value, defense by the weapon object W can be rendered impossible by invalidating the hit determination between the weapon object W and another object. As a result, the user 5 is inhibited from passive play, such as constantly defending behind the weapon object W.

When the collision area CD of the weapon object W is invalidated in Step S1918 or when a collision between the weapon object W and the attack object A is not detected in Step S1914, the defense against the attack object A by the weapon object W fails. In this case, in Step S1919, the processor 210 determines, based on the collision area CD and the collision area CF, whether the avatar object 6 and the attack object A have collided. When a collision is not detected (Step S1919: NO), the processor 210 ends the processing. On the other hand, when a collision is detected (Step S1919: YES), in Step S1920, the processor 210 reduces the physical strength value of the avatar object 6 based on the inflicted damage amount determined in advance (e.g., inflicted damage amount determined based on an attack strength associated with attack object A and a defense strength associated with avatar object 6).

In at least the above example, there is described a case in which the predetermined parameter is the physical strength value associated with the avatar object 6, but the predetermined parameter is not limited to this. For example, the predetermined parameter may be an anger level of the avatar object 6 (e.g., parameter for changing a special technique to a usable state when the anger level has risen to a fixed level or more) or the like.

[Action Evaluation]

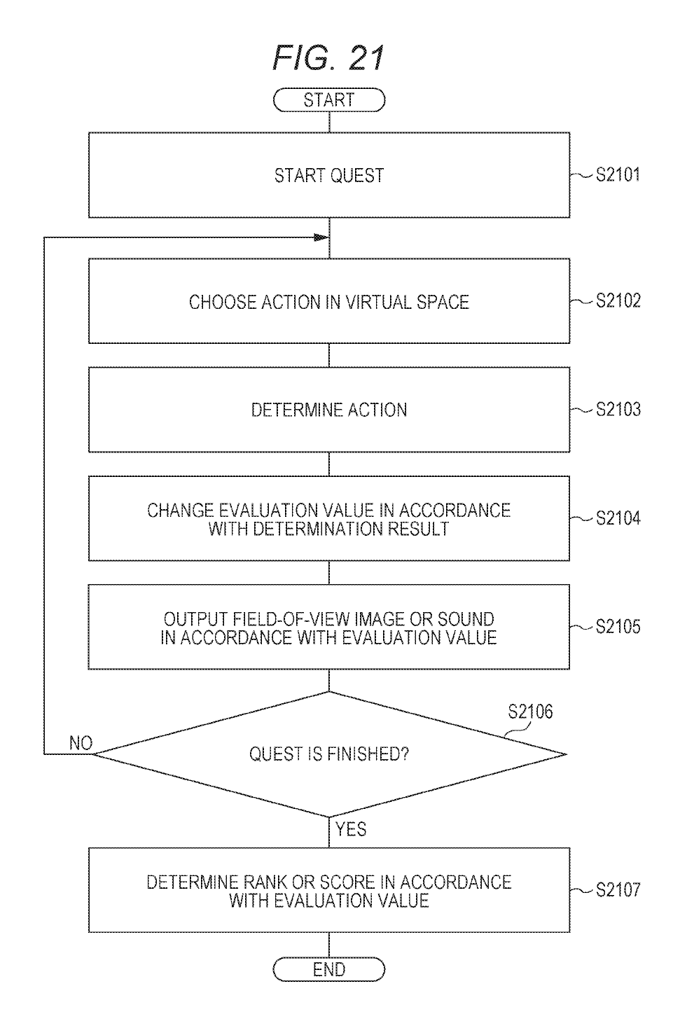

At least one processing procedure for evaluating an action of the user 5 in the virtual space 11 is now described with reference to FIG. 21 to FIG. 24A and FIG. 24B. In at least one embodiment, the processor 210 changes the evaluation value based on the individual actions of the user 5 in a quest (or stage) provided by the game content developed in the virtual space 11. The processor 210 determines a game rank, a score, or the like of the user 5 based on a final evaluation value. A quest is finished by, for example, achieving an objective (e.g., defeating a specific enemy character) set for the quest. The quest also finishes when the user fails to achieve the objective set for the quest (e.g., when the physical strength value of the avatar object 6 becomes 0 or when a limit duration determined in advance is exceeded).

In Step S2101, the processor 210 starts a quest selected by the user 5. For example, the processor 210 may display in the virtual space 11 a menu screen for selecting a quest. The processor 210 may also enable the user 5 to select a quest by touching the menu screen with the hand object 1541 (or an object such as a touch pen operated by the hand object 1541).

In Step S2102, the processor 210 chooses the action of the user 5 in the virtual space 11. Specifically, the processor 210 moves the avatar object 6 based on the detected motion of the HMD 120, and moves the hand object 1541 based on the detected motion of the hand of the user 5. When another object is held in the hand object 1541, the processor 210 moves that another object together with the hand object 1541. This processing corresponds to the processing of Step S1608 of FIG. 16.

In Step S2103, the processor 210 serves as the action evaluation module 1428 to determine the action chosen in Step S2102. More specifically, the processor 210 determines whether the action is an active motion determined in advance or a passive motion determined in advance. An active motion is a motion determined in advance as being a motion that looks good when playing the game in the virtual space 11, and such a motion increases the evaluation value. A passive motion is a motion determined in advance as being a motion that does not look good when playing the game, and such a motion reduces the evaluation value.

### Determination Examples

The processor 210 may determine that the action of the user 5 is a passive motion when a motion determined in advance for the HMD 120 or the hand (part of body) of the user 5 has not been detected for a duration determined in advance or longer. The motion determined in advance is, for example, a motion occurring when the HMD 120 or the hand of the user 5 moves by a distance equal to or more than a predetermined distance. In other words, a motion equivalent to being stationary at substantially the same position while slightly swaying does not correspond to the motion determined in advance. As a result of this determination, when the user 5 has not performed an action having a substantial meaning in the game and is not actively performing an attack motion or the like on the enemy object E, the action of the user 5 can be determined to be passive.

The processor 210 may determine the action of the user 5 based on the position in the virtual space 11 corresponding to the detected position of the HMD 120 or the hand of the user 5. For example, when the position in the virtual space 11 is included in a safe zone set in advance as an area in which the attack from the enemy object E (attack object A) does not hit, and that state has continued for a duration determined in advance or longer, the processor 210 may determine that the action of the user 5 is a passive motion.

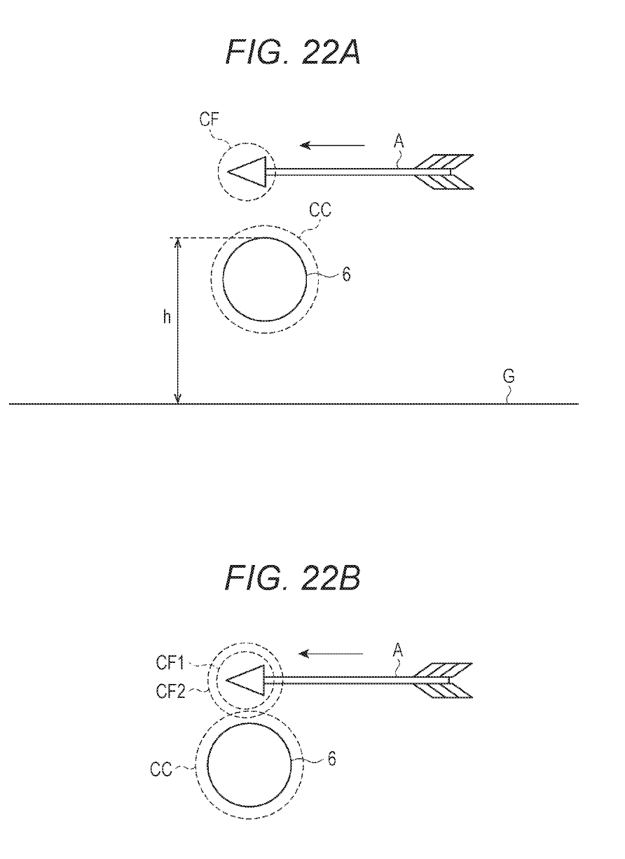

The processor 210 may determine the action of the user 5 based on the height in the virtual space 11 corresponding to the detected position of the HMD 120 or the hand of the user 5. In FIG. 22A, for example, when the user 5 is crouching down and a height (height h of avatar object 6 with respect to virtual ground G set in virtual space 11) in the virtual space 11 corresponding to the detected position of the HMD 120 is lower than the predetermined height, the attack from the attack object A may not hit (or is unlikely to hit). Therefore, for example, when a state in which the height h of the avatar object 6 in the virtual space 11 is lower than the predetermined height continues for a duration determined in advance or longer, the processor 210 may determine that the action of the user 5 is a passive motion.

In the collision control described above, when a collision between the weapon object W and the enemy object E or the attack object A is detected, the user 5 is actively performing an attack motion or a defensive motion. Therefore, when a collision between the weapon object W and the enemy object E or the attack object A is detected, the processor 210 may determine that the action of the user 5 is an active motion.

On the other hand, when an operation object (e.g., armor object D resembling a shield) for defending against attacks from the attack object A is associated with the hand object 1541 and a defensive motion by the armor object D is continued for a duration determined in advance or longer, the user 5 is only performing a defensive motion and is not actively performing an attack motion. In such a case, the processor 210 may determine that the action of the user 5 is a passive motion.

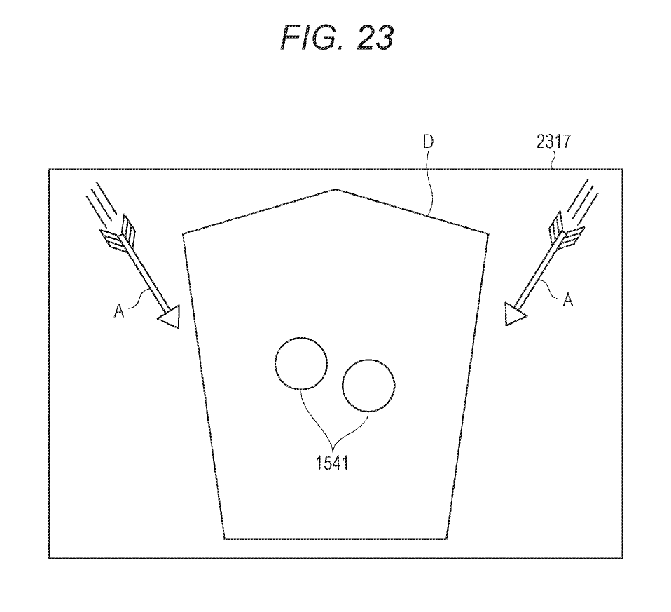

Whether or not a defensive motion by the armor object D is being performed may be determined based on a ratio occupied by the armor object D in a field-of-view image 2317. In FIG. 23, there is at least one example of a field-of-view image M in a state in which the user 5 is performing a defensive motion to defend against an attack from the attack object A by hiding behind the armor object D. In the field-of-view image 2317, the back side (side gripped by the hand) portion of the armor object D resembling a shield is displayed. When such a defensive motion is being performed, the display area of the armor object D in the field-of-view image 2317 tends to be large. Therefore, when the display area of the armor object D in the field-of-view image 2317 is equal to or more than a threshold determined in advance, the processor 210 may determine that a defensive motion by the armor object D is being performed.

A motion for avoiding the attack object A by the user 5 moving his or her body may be said to be a motion that looks good. Therefore, when the action of the user 5 corresponds to an avoidance motion for avoiding the attack object A, the processor 210 may determine that the action is an active motion.

Whether or not a motion is an avoidance motion may be determined as follows. Specifically, during a period in which a series of attack motions by the attack object A is being executed, when a motion of the HMD 120 is detected but a collision between the collision area CC (first collision area) of the avatar object 6 and the collision area CF (second collision area) of the attack object A is not detected, the processor 210 may determine that the action of the user 5 is an avoidance motion. The start point of the series of attack motions of the attack object A is, for example, the timing at which the attack object A has approached within a threshold distance determined in advance from the avatar object 6. The start point of the series of attack motions of the attack object A may also be, for example, the timing at which an attack motion set in advance (e.g., timing at which attack object A is released) is executed in the program defining the motion of the enemy object E.

Among the above-mentioned avoidance motions, a motion for barely avoiding the attack from the attack object A (hereinafter referred to as “specific avoidance motion”) may be said to be a particularly good motion. Therefore, when the action of the user 5 corresponds to the specific avoidance motion, the processor 210 may determine that the action is an active motion (or among active motions, a motion having a particularly large increase in evaluation value).

The processor 210 sets, for example, a collision area CF1 (collision area similar to above-described collision area CF) defining a range within which the avatar object 6 may be attacked by the attack object A, and a collision area CF2 (third collision area) encompassing the collision area CF1. When a collision between the collision area CC and the collision area CF1 is not detected but a collision between the collision area CC and the collision area CF2 is detected, the processor 210 may determine that the action of the user 5 is the specific avoidance motion. In FIG. 22B, there is illustrated an example of such a specific avoidance motion. Through setting of two collision areas and determination of whether a collision has occurred only in the outer collision area, the specific avoidance motion is easily determined with a small calculation load. The sense of elation by the user 5 is increased regarding the game by prompting the user 5 to take action at the last possible moment so that whether the attack by the enemy hits is a close call.

The processor 210 may execute the following processing as specific processing for determining the action of the user 5 based on whether the action corresponds to an avoidance motion. More specifically, before the start of a series of attack motions of the attack object A, the processor 210 calculates a trajectory of the collision area CF (i.e., provisional motion representing future motion of collision area CF) in the series of attack motions. When the collision area CC at the start of the series of attack motions and the trajectory of the collision area CF overlap, but a collision between the collision area CC at the start of the series of attack motions and the trajectory of the collision area CF is not actually detected, the processor 210 determines that the action of the user 5 is an active motion.

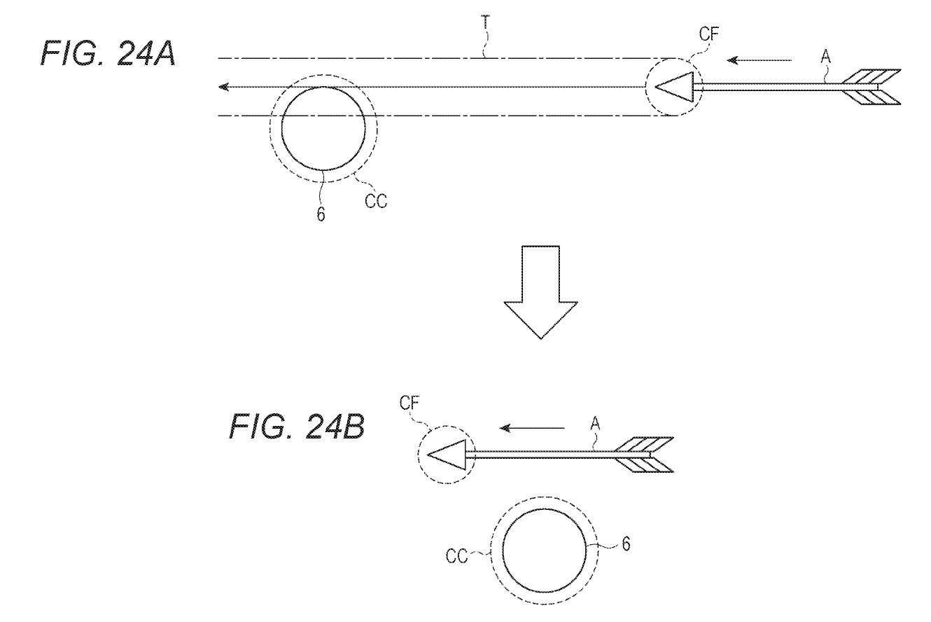

FIG. 24A is a diagram of a trajectory T of the collision area CF in a series of attack motions of the attack object A according to at least one aspect of this disclosure. In at least this example, the trajectory T represents a locus extending in a columnar shape advancing straight toward the avatar object 6. In FIG. 24A, there is a state in which the collision area CC at the start of the series of attack motions and the trajectory T overlap. In FIG. 24B, there is a state in which the attack from the attack object A is avoided by the user 5 moving his or head (i.e., HMD 120). In this way, when the avoidance motion is successful, a collision between the collision area CC and the collision area CF is not detected when the series of attack motions is executed. Therefore, in at least the example in FIG. 24A and FIG. 24B, the processor 210 determines that the action of the user 5 is an active motion.

In this way, by generating the provisional motion (trajectory T) of the attack object A and performing a determination based on the trajectory T before the actual attack motion is executed, whether the action of the user 5 corresponds to an avoidance motion is accurately determined.

In Step S2104, the processor 210 serves as the action evaluation module 1428 to change the evaluation value associated with the user 5 in accordance with the determination result of the action. More specifically, in response to a determination that the action is an active motion the processor 210 increases the evaluation value. On the other hand, in response to a determination that the action is a passive motion the processor 210 reduces the evaluation value. As a result, the evaluation value is increased when the action of the user 5 translated in the virtual space 11 is a good motion, and the evaluation value is reduced when the action of the user 5 is not a good motion.

In Step S2105, the processor 210 serves as the action evaluation module 1428 to execute predetermined game control based on the determination result (change in evaluation value) of each action of the user 5. For example, the processor 210 may output to the monitor 130 a field-of-view image in which a message (e.g., characters such as “Cool!” and “Uncool”) corresponding to the determination result of the action is displayed. The processor 210 may also output to a speaker or the like a sound corresponding to the determination result of the action. In this way, through notifying the user 5 of the determination result of the action of the user 5, it is possible to give the user 5 a pleasant feeling when the determination result of the action is good, and to prompt the user to perform a good motion when the determination result of the action is poor.

In Step S2106, the processor 210 determines that the quest has finished. The processor 210 repeatedly executes the processing of Step S2102 to Step S2105 until the quest finishes. When the quest has finished, in Step S2107, the processor 210 serves as the action evaluation module 1428 to execute predetermined game control based on the determination result (final evaluation value) of the actions of the user 5 in the quest. For example, the processor 210 determines a rank or a score in accordance with the final evaluation value. The processor 210 may also determine a reward (e.g., specific item usable in the game) to be given to the user 5 based on the rank and the like determined in this way.

With the action evaluation processing described above, the user 5 is prompted to take active motions by highly evaluating actions corresponding to active motions. More specifically, the user 5 is prompted to take good actions intended by the game provider, and through giving a high evaluation value to the user 5 actually taking such actions, the sense of elation by the user 5 regarding the game may be effectively increased.

This concludes descriptions of at least one embodiment of this disclosure. However, the descriptions of at least one embodiment are not to be read as a restrictive interpretation of the technical scope of this disclosure. At least one embodiment is merely given as an example, and it is to be understood by a person skilled in the art that various modifications can be made to at least one embodiment within the scope of this disclosure set forth in the appended claims. The technical scope of this disclosure is to be defined based on the scope of this disclosure set forth in the appended claims and an equivalent scope thereof.

For example, in at least one embodiment, there is described collision control between the operation object (weapon object W) and the target object (enemy object E or attack object A), but the combination on which the collision control is to be performed is not limited to that example. For example, in a game in which the enemy object E is attacked by a bare hand (hand object 1541) or a game in which the attack object A is knocked down by a bare hand (hand object 1541), the processor 210 may execute the above-mentioned collision control between the hand object 1541 and the enemy object E or the attack object A.

In at least one embodiment, there is described a case in which the avatar object 6 is only a part corresponding to the head of the user 5, but the avatar object 6 may include a part other than the head, such as the body and legs, for example. When the HMD set 110 includes sensors and cameras capable of tracking the motion of part of the body other than the head and the hands of the user 5, the processor 210 may move the part of the avatar object 6 corresponding to that part in accordance with the motion thereof.

The processing procedure in the flowchart described in at least one embodiment is merely an example, and a part of the processing may be omitted or changed, other processing may be added, or even the processing order may be changed. In the processing of the processor 210 described above, when comparing the relationship in magnitude between two numerical values, any one of the two criteria “equal to or more than” and “more than” may be used, and any one of the two criteria “equal to or less than” and “less than” may be used. The selection of such criteria does not change the technical significance of the processing of comparing the relationship in magnitude between the two numerical values.

In at least one embodiment, the movement of the hand object is controlled in accordance with the motion of the controller 300 indicating the motion of the hand of the user 5, but the movement of the hand object in the virtual space may also be controlled in accordance with a movement amount of the hand of the user 5 per se. For example, in place of using the controller 300, a glove type device, a ring type device, or the like worn on the fingers of the user finger may be used. In this case, the position, the movement amount, and the like of the hand of the user 5, as well as the motion, the state, and the like of the fingers of the user 5, can be detected by the HMD sensor 410. In place of the HMD sensor 410, the motion, the state, and the like of the fingers of the user 5 may be detected by a camera configured to photograph the hand (including fingers) of the user 5. As a result of photographing the hand of the user 5 using the camera, wearing some kind of device directly on the fingers of the user 5 is not required. In this case, the position and the movement amount of the hand of the user 5, as well as the motion, the state, and the like of the fingers of the user, can be detected based on image data in which the hand of the user 5 is displayed.

In at least one embodiment, the hand object that moves together with the motion of the hand of the user 5 is used as the operation object, but at least one embodiment is not limited to this. For example, a foot object that moves together with the motion of a foot of the user 5 may be used as the operation object in place of, or together with, the hand object.

In at least one embodiment, a virtual experience in a first-person viewpoint is provided to the user 5 by causing the visual field of the user defined by the virtual camera 14 to match the visual field of the avatar object 6 in the virtual space 11, but at least one embodiment is not limited to this. For example, through arranging the virtual camera 14 behind the avatar object 6, a virtual experience in a third-person viewpoint in which the avatar object 6 is included in the field-of-view image may be provided to the user 5.

The game to be provided in the virtual space 11 is not limited to a battle game like that described above in at least one embodiment, and may be a game of various genres. The game is not limited to a game to be provided as game content (game software). For example, the game may be a mini game or the like to be provided as content that in a normal state does not have game elements, such as a chat (VR chat) among a plurality of users in the virtual space 11.

In the at least one embodiment described above, the description is given by exemplifying the virtual space (VR space) in which the user is immersed using an HMD. However, a see-through HMD may be adopted as the HMD. In this case, the user may be provided with a virtual experience in an augmented reality (AR) space or a mixed reality (MR) space through output of a field-of-view image that is a combination of the real space visually recognized by the user via the see-through HMD and a part of an image forming the virtual space. In this case, action may be exerted on a target object in the virtual space based on motion of a hand of the user instead of the operation object. Specifically, the processor may identify coordinate information on the position of the hand of the user in the real space, and define the position of the target object in the virtual space in connection with the coordinate information in the real space. With this, the processor can grasp the positional relationship between the hand of the user in the real space and the target object in the virtual space, and execute processing corresponding to, for example, the above-mentioned collision control between the hand of the user and the target object. As a result, an action is exerted on the target object based on motion of the hand of the user.

The method of determining the collision effect based on the movement speed of the operation object is not limited. For example, the size of the collision area may be increased or reduced more by the processor 210 when the movement speed of the operation object is faster. The processor 210 may also increase or reduce a predetermined parameter (e.g., parameter associated with target object or parameter associated with user) by a larger amount when the movement speed of the operation object is faster.

The subject matter disclosed herein is represented as, for example, the following Items.

(Item 1)

An information processing method to be executed on a computer 200 in order to provide a virtual experience to a user 5 via a head-mounted device (HMD 120) including a display (monitor 130), the information processing method including generating virtual space data defining a virtual space 11 including an operation object that includes at least one of the hand object 1541 associated with a hand of the user 5 or an object (in at least one embodiment, weapon object W) to be operated by the hand object 1541, and a target object (in at least one embodiment, enemy object E or attack object A) that interacts with the operation object (Step S1601 of FIG. 16). The method further includes detecting a motion of the head-mounted device and a motion of the hand of the user 5 (Step S1605 and Step S1607 of FIG. 16). The method further includes moving the operation object in accordance with the motion of the hand of the user 5 (Step S1608 of FIG. 16). The method further includes determining, based on a movement speed of the operation object, a collision effect to be associated with the operation object (Step S1701 and Step S1702 of FIG. 17, or Step S1912 and Step S1913 of FIG. 19). The method further includes executing, when the operation object and the target object have collided, processing in accordance with a relationship between the operation object and the target object (Step S1706 of FIG. 17 or S1917 of FIG. 19). The method further includes generating a field-of-view image based on the virtual space data and the motion of the head-mounted device, and displaying the field-of-view image on the display (Step S1610 of FIG. 16).

According to this information processing method, a more intuitive virtual experience may be provided to the user by determining the collision effect in accordance with the movement speed of the operation object. As a result, the entertainment value of the virtual experience of the user may be improved.

(Item 2)

An information processing method according to Item 1, wherein the collision effect includes a size of a collision area associated with the operation object or a variation amount of a predetermined parameter produced in response to a determination based on the collision area that the operation object and the target object have collided.

According to this information processing method, a more intuitive virtual experience may be provided to the user by determining the size or the effect (variation amount of parameter) of the collision area in accordance with the movement speed of the operation object. As a result, the entertainment value of the virtual experience of the user may be improved.

(Item 3)

An information processing method according to Item 2, further including increasing or decreasing the size of the collision area when the movement speed of the operation object is faster.

According to this information processing method, a more intuitive virtual experience may be provided to the user by adjusting the ease with which the operation object and another object collide in accordance with the movement speed of the operation object.

(Item 4)

An information processing method according to Item 2, wherein the predetermined parameter includes a parameter associated with the target object, and the method further includes increasing or decreasing the variation amount of the predetermined parameter when the movement speed of the operation object is faster.

According to this information processing method, for example, when the movement speed of a weapon object, which is the operation object, is faster, a damage amount inflicted on an enemy object, which is the target object, may be increased or reduced more. As a result, it is possible to prompt the user to enjoy the game by dynamically moving his or her body.

(Item 5)

An information processing method according to Item 2, wherein the predetermined parameter includes a parameter associated with the user, and the method further includes increasing or decreasing the variation amount of the predetermined parameter when the movement speed of the operation object is faster.

According to this information processing method, it is possible to, for example, reduce or increase the inflicted damage amount on the player character received from the attack object, which is the target object, when the movement speed of the weapon object, which is the operation object, is faster. As a result, it is possible to prompt the user to enjoy the game by dynamically moving his or her body.

(Item 6)

An information processing method according to any one of Items 1 to 5, further including invalidating the collision area when the movement speed of the operation object is equal to or less than a threshold determined in advance.

According to this information processing method, it is possible to inhibit passive play (e.g., such as constantly defending behind the weapon object) in which the user does not substantially move the operation object.

(Item 7)

An information processing method according to any one of Items 1 to 5, further including determining the collision effect based on a movement direction of the operation object with respect to the target object.

According to this information processing method, the collision effect can be appropriately determined based on the movement direction of the operation object with respect to the target object. This enables further improvement in game enjoyment.

(Item 8)

A system for executing the information processing method of any one of Items 1 to 7.

(Item 9)

An apparatus, including at least a memory and a processor coupled to the memory, the apparatus being configured to execute the information processing method of any one of Items 1 to 7 under control of the processor.

(Item 10)

An information processing method to be executed on a computer 200 in order to provide a game in a virtual space 11 to a user 5 via a head-mounted device (HMD 120) including a display (monitor 130), the information processing method including generating virtual space data defining the virtual space 11 (Step S1601 of FIG. 16). The method further includes detecting a motion of the head-mounted device and a motion of a part of a body other than a head of the user 5 (Step S1605 and Step S1607 of FIG. 16). The method further includes choosing an action of the user 5 in the virtual space 11 based on the motion of the head-mounted device or the motion of the part of the body (Step S1608 of FIG. 16 and Step S2102 of FIG. 21). The method further includes changing an evaluation value associated with the user 5 such that the evaluation value is increased when the action is an active motion determined in advance and is reduced when the action is a passive motion determined in advance (Step S2104 of FIG. 21). The method further includes performing predetermined game control based on the evaluation value (Step S2105 or Step S2107 of FIG. 21). The method further includes generating a field-of-view image based on the virtual space data and the motion of the head-mounted device, and displaying the field-of-view image on the display (Step S1610 of FIG. 16).

According to this information processing method, the user is prompted to take active actions by giving a high evaluation value to an action corresponding to an active action, and the sense of elation by the user 5 is increased regarding the game by controlling the game based on the evaluation value (e.g., outputting a message or sound corresponding to the evaluation value).

(Item 11)

An information processing method according to Item 10, wherein when a motion determined in advance for the head-mounted device or the part of the body has not been detected for a duration determined in advance or longer, the action is the passive motion.

According to this information processing method, when the user has not performed an action having a substantial meaning in the game, processing may be executed based on the assumption that the action of the user is a passive motion.

(Item 12)

An information processing method according to Item 10 or 11, further including determining the action to be any one of the active motion and the passive motion based on a position in the virtual space 2 corresponding to the detected position of the head-mounted device or the part of the body.

According to this information processing method, the action of the user may be appropriately determined based on a characteristic peculiar to the position in the virtual space (e.g., whether the user is in a safe area or the like in the game).

(Item 13)

An information processing method according to Item 12, wherein the determining of the action includes determining the action to be any one of the active motion and the passive motion based on a height in the virtual space 11 corresponding to the detected position of the head-mounted device or the part of the body.

According to this information processing method, the action of the user can be appropriately determined based on a characteristic peculiar to the height in the virtual space (e.g., whether the user is at a height that is not hit by attacks from the enemy).

(Item 14)

An information processing method according to any one of Items 10 to 13, wherein the virtual space 11 includes an operation object including at least one of a body object (in at least one embodiment, hand object 1541) associated with a part of a body of the user 5 or an object (in at least one embodiment, weapon object W, armor object D, and the like) to be operated by the body object, and a target object (in at least one embodiment, enemy object E or attack object A) to be attacked or defended against by the operation object. The method further includes moving the operation object in accordance with a motion of the part of the body of the user 5 (Step S1608 of FIG. 16). The determining of the action includes determining the action to be the active motion when the operation object and the target object have collided.

According to this information processing method, the action of the user may be appropriately determined to be an active motion when the user has performed an attack motion or a defensive motion.

(Item 15)

An information processing method according to any one of Items 10 to 13, wherein the virtual space 11 includes an operation object including at least one of a body object associated with a part of a body of the user 5 or an object to be operated by the body object, and a target object (in at least one embodiment, attack object A) to be defended against by the operation object. When a defensive motion by the operation object for defending against an attack from the target object has continued for a duration determined in advance or longer, the action is the passive motion.

According to this information processing method, when the user is exclusively performing a defensive motion and is not actively performing an attack motion, processing can be executed based on the assumption that the action of the user is a passive motion.

(Item 16)

An information processing method according to any one of Items 10 to 13, wherein the virtual space 11 includes a character object (avatar object 6) moving in the virtual space 11 in accordance with the motion of the head-mounted device and a target object (attack object A) that attacks the character object. A first collision area (collision area CC) is set for the character object, and a second collision area (collision area CF or CF1) defining a range within which the target object is capable of attacking the character object is set for the target object. When a motion of the head-mounted device is detected but a collision between the first collision area and the second collision area is not detected while a series of attack motions of the target object is executed, the action is the active motion.

According to this information processing method, when an avoidance motion has been performed by the user, processing can be executed based on the assumption that the action of the user is an active motion.

(Item 17)

An information processing method according to Item 16, wherein a third collision area (collision area CF2) encompassing the second collision area is further set for the target object, and when a collision between the first collision area and the second collision area is not detected but a collision between the first collision area and the third collision area is detected, the action is the active motion.

According to this information processing method, particularly when the user performs an avoidance motion (specific avoidance motion) at the last possible moment so that it is a close call whether the attack by the enemy hits, processing is executed based on the assumption that the action of the user is an active motion. Prompting such a specific avoidance motion to be performed enables the sense of elation by the user 5 regarding the game to be further increased.

(Item 18)

An information processing method according to Item 16, further including calculating a trajectory T of the second collision area in the series of attack motions before the series of attack motions starts, wherein when the first collision area at the start of the series of attack motions and the trajectory T overlap, but a collision between the first collision area and the second collision area is not detected when the series of attack motions is executed, the action is the active motion.

According to this information processing method, whether the action of the user corresponds to an avoidance motion may be accurately identified based on the trajectory of the second collision area.

(Item 19)

A system for executing the information processing method of any one of Items 10 to 18.

(Item 20)

An apparatus, including at least a memory and a processor coupled to the memory, the apparatus being configured to execute the information processing method of any one of Items 10 to 18 under control of the processor.

1-11. (canceled)

12. A method, comprising:
defining a virtual space, wherein the virtual space comprises an operation object and a target object;
detecting a motion of a hand of a user;
moving the operation object in accordance with the detected motion of the hand of the user;
detecting a movement speed of the operation object or the hand of the user;
determining whether the operation object and the target object have collided in the virtual space;
determining whether a predetermined parameter associated with the virtual space is to be varied in accordance with the determination that the operation object and the target object have collided; and
identifying a variation amount f the predetermined parameter based on the detected movement speed.

13. The method according to claim 12, wherein the predetermined parameter comprises a parameter associated with the user.

14. The method according to claim 12, wherein the predetermined parameter comprises a parameter associated with the target object.

15. The method according to claim 12,
wherein the operation object comprises a hand object and a weapon object,
wherein the method further comprises:
moving the hand object in accordance with the detected motion of the hand of the user;
associating the weapon object with the hand object; and
moving the weapon object in accordance with the motion of the hand object.

16. The method according to claim 12, further comprising:
setting a collision area in association with the operation object;
moving the collision area in accordance with the motion of the operation object; and
determining the operation object and the target object to have collided in accordance with a positional relationship between the collision area and the target object.

17. The method according to claim 12, the determining whether the operation object and the target object have collided comprises determining that the operation object and the target object have not collided in response to the movement speed being equal to or less than a threshold.

18. The method according to claim 12, further comprising maintaining the predetermined parameter in response to the movement speed being equal to or less than a threshold.

19. The method according to claim 12, further comprising:
identifying a movement direction of the operation object;
identifying a movement direction of the target object; and
determining the variation amount of the predetermined parameter in accordance with the movement direction of the operation object with respect to the movement direction of the target object.

20. The method according to claim 19, wherein the determining of the variation amount comprises determining the variation amount of the predetermined parameter in response to the movement direction of the operation object being different from the movement direction of the target object.

21. The method according to claim 19, the determining whether the operation object and the target object have collided comprises determining that the operation object and the target object have not collided in response to the movement direction of the operation object and the movement direction of the target object being a same direction.

22. The method according to claim 19, further comprising maintaining the predetermined parameter in response to the movement direction of the operation object and the movement direction of the target object being a same direction.

23. The method according to claim 12, further comprising:
detecting a motion of a head-mounted device (HMD);
identifying a visual field in the virtual space in accordance with the motion of HMD;
generating a visual-field image in accordance with the visual field; and
displaying the visual-field image on the HMD.

24. The method according to claim 16, further comprising:
changing a size of the collision area in accordance with the detected movement speed.

25. A method, comprising:
defining a virtual space, wherein the virtual space comprises:
an operation object having a first collision area, and
a target object having a second collision area;
moving the operation object in accordance with the detected motion of the user;
detecting a movement speed of the operation object;
determining a size of the first collision area based on the detected movement speed;
determining whether the operation object and the target object have collided based on the first collision area contacting the second collision area in the virtual space.

26. The method according to claim 25, wherein the determining of the size of the first collision area comprises reducing the size of the first collision area to zero in response to no movement of the operation object for a predetermined time.

27. The method according to claim 25, wherein the operation object is a hand object in the virtual space corresponding to a hand of the user in a real space.

28. The method according to claim 27, wherein the operation object is a weapon object in the virtual space.

29. The method according to claim 25, wherein the determining of the size of the first collision area comprises reducing the size of the first collision area in response the detected movement speed being below a threshold value.

30. The method according to claim 25, further comprising determining whether a predetermined parameter associated with the virtual space is to be varied in accordance with the determination that the operation object and the target object have collided.

31. A system comprising:
a non-transitory computer readable medium configured to store instructions thereon; and
a processor connected to the non-transitory computer readable medium, wherein the processor is configured to execute the instructions for:
defining a virtual space, wherein the virtual space comprises an operation object and a target object;
determining a motion of a hand of a user;
moving the operation object in accordance with the detected motion of the hand of the user;
determining a movement speed of the operation object or the hand of the user;
determining whether the operation object and the target object have collided in the virtual space;
determining whether a predetermined parameter associated with the virtual space is to be varied in accordance with the determination that the operation object and the target object have collided; and
identifying a variation amount of the predetermined parameter based on the detected movement speed.
